(19) United States
(12) Patent Application Publication
(10) Pub. No.: US 2023/0356799 A1
(43) Pub. Date: Nov. 9, 2023

(54) MODULAR CARGO BIKE

(71) Applicant: Lior Bazak, Sr., Atlit (IL)

(72) Inventor: Lior Bazak, Sr., Atlit (IL)

(21) Appl. No.: 18/021,818

(22) PCT Filed: Aug. 26, 2021
(86) PCT No.: PCT/IL2021/051049

§ 371 Date: Feb. 17, 2023

(51) Int. Cl. B62K 5/027; B62K 7/04; B62K 5/06

(52) U.S. Cl. CPC B62K 7/04; B62K 5/027; B62K 5/06; B62K 2204/00

(57) ABSTRACT

A cargo bike frame is disclosed, comprising: a first module comprising a drive system and a first frame section having one or more first telescopic tube elements; and a second module comprising a steering system, a suspension system, and a second frame section having a cargo cabin mount and one or more second telescopic tube elements; wherein the one or more first telescopic tube elements are detachably connected to the one or more second telescopic tube elements to form one or more telescopic tubes of adjustable length, thereby connecting the first module to the second module at an adjustable distance; and wherein, when the cargo bike frame is in an upright standing position, the one or more telescopic tubes are in a substantially horizontal position at a height lower than the heights of the steering system and the suspension system. A steering solution and cargo cabin for a cargo bike are also disclosed.

### FIELD OF INVENTION

The technology relates to the general field of cargo bikes, and has certain specific applications to door to door transport solutions.

### BACKGROUND

The use of bicycles and tricycles as tools for cargo and child transport are known, and some attempts have been made to allow adjustments in the dimensions and shape of these cargo bikes. However, the structural challenges of compressing a standard full length cargo bike down into a vehicle such as a stroller that can be easily maneuvered indoors whilst maintaining cargo carrying functionality, and without arduous disassembling and reassembling processes, have prevented the appearance of a single door to door cargo solution.

As such, in the current market, a user must choose between the speed and convenience of a full-sized cargo bike and the maneuverability and ability to travel indoors of a stroller or trolley type vehicle. There is no single solution or vehicle capable of flexibly providing a full “door to door” journey whilst transporting large amounts of heavy, bulky cargo.

One main area of compromise for existing cargo bike solutions is the level of modularity integration of the vehicle parts. That is, the ease with which a user can convert the vehicle from one mode to the other. As mentioned above, the user is often required to perform a disassembling process where parts of the vehicle are fully separated from each other, this introduces problems in situations such as, for example, where the user is transporting young children, who would have to be taken out of the cargo cabin and left on their own while the bike is dismantled.

A second area of compromise is on bicycle industry-standards in safety and standard size of parts. That is, in many adjustable cargo bike solutions the construction of the frame is such that it is incompatible with industry standard sized bicycle parts, which limits riding performance, loading capabilities, foldability, and safety.

The present invention fulfills the above-described need for a versatile door to door cargo bike solution, combining outdoor riding ability with easy access to elevators as a stroller in a seamless conversion using an integrated modular frame structure. Furthermore, the conversion ability of the present invention can be affected in a single “press & push” operation, and without any parts to assemble in the conversion between the modes, as will be described below.

### SUMMARY

The present invention provides a modular cargo bike or tricycle frame having a telescopic tube mechanism for adjusting the distance between a first module and a second module, i.e. front and rear modules, thereby enabling conversion between a standard cargo bike mode to stroller or cart via a single operation, for example a “press & push” function that takes less than 4-6 seconds to complete, without the need of disassembling and reassembling of parts.

Thus, according to a first aspect of the present invention, there is provided a cargo bike frame, comprising: a first module, the first module comprising a drive system and a first frame section comprising a dual head mechanism mounted to a central frame portion, the dual head mechanism having first and second openings forming a pair of first telescopic tube elements; and a second module, the second module comprising a steering system, a suspension system, and a second frame section having a cargo cabin mount and two inner tubes forming a second pair of one or more second telescopic tube elements; wherein the one or more first pair of telescopic tube elements are configured to receive and thus detachably connected to the one or more second pair of telescopic tube elements to form two telescopic tubes of adjustable length, thereby connecting the first module to the second module at an adjustable distance; and wherein, when the cargo bike frame is in an upright standing position, the one or more telescopic tubes are in a substantially horizontal position at a height lower than the heights of the steering system and the suspension system.

In some embodiments, the cargo bike frame further comprising a length-locking means within the dual head, whereby one or more of the telescopic tubes are configured with a plurality of lock points, enabling the distance between the first module and the second module to be set to a corresponding plurality of predetermined distances. The length-locking mechanism may comprises a plurality of pin holes in one or more of the second telescopic tube elements and a pin-lock mechanism configured to insert a pin in one of the plurality of pin holes. Further, a user may control the length-locking mechanism via actuation of a trigger located on the second module.

Furthermore, both of the telescopic tubes may be incorporated into the length locking mechanism, and wherein the trigger operates a pair of cables connected to a pair of spring mechanisms within the dual head for operating the pin-locks.

In some embodiments, the one or more first telescopic tube elements comprise female telescopic tube elements and the one or more second telescopic tube elements comprise male telescopic tube elements configured to slide through and parallel to the first telescopic tube elements. The one or more first telescopic tube elements may comprise an inner coating configured to reduce friction with respect to the second telescopic tube elements. The inner coating may be formed of Nylon6 material.

In some embodiments, the second module is configured to receive and support a cargo cabin which is up to 800 mm in length.

In some embodiments, the variable distance between the first and second modules afforded by the telescopic tube configuration allows for the assembled cargo bike to reduce its length by up to 44% from a first full-length open position to a second minimum length closed position.

In some embodiments, the drive system comprises a crankset. In other embodiments, the drive system comprises and electric motor.

A telescopic bike folding system according to the present invention may enable a frame length reduction capability of up to 44% from a total bike length, which means the frame solution can take, for example, a standard cargo bike with a length of 1950 mm and reduce the length down to 1200 mm (75 cm less in length) while maintaining all bicycle industry standard components such as 26″ rear wheel, rear gear, crankset system, and an up to 800 mm length front cabin capable of carrying multiple children or alternatively a heavy and bulky cargo supported by a full front suspension system.

In the above example, the total length of 1950 mm would be in a full “Open frame bicycle mode” and minimum length achievable of 1150 mm to 1200 mm would be a fully closed “Closed frame stroller mode”. This versatility is advantageous because it allows the use of transporting children or any other heavy large cargo by riding anywhere outdoors on most roads and strolling anywhere in indoor areas such as malls, schools, houses and with the ability to use public transportation due to the ability of the bike in a stroller mode to enter elevators and trains/metro platforms. This capability enables the rider to ride freely on all bicycle roads and off-road and also to pass through any entrance having a width of 80 cm or more without turning or lifting the bike, providing the rider with absolute logistic independence.

In some embodiments, the second module forms a reinforced cage structure to support the cargo cabin mount.

The reinforced cage structure may comprise an upper layer configured to receive a cargo cabin and support the base of an adapted steering system, and a lower layer shaped to encompass the suspension and telescopic tube mechanism, the upper layer and lower layer being vertically connected by one or more reinforced bridges.

The steering system may be adapted to keep a central space beneath the steering handles free for the seat of the first module to slide into, and is further adapted to keep a space in front of the steering handles free to maximize space for the cargo cabin.

The steering system may comprise a shortened central steering shaft disposed rearwards of the cabin mount and ending in a first central pulley having a steering cable disposed thereon which connects via a left pulley assembly and a right pulley assembly to a second central pulley disposed within the reinforced cage structure and which confers turning motion applied to the steering handles to a second shaft connected to the frame suspension.

In some embodiments, the second module comprises a retractable tray mechanism for supporting one or more luggage items on a front of the cargo bike in addition to the cabin.

The retractable tray mechanism may be spring operated such that the tray slides out automatically when pressed inwards.

In some embodiments, the first module comprises a retractable handle disposed rearwards of the seat for a passenger to grip.

Thus the invention solution solves multiple engineering and geometrical challenges to provide a versatile modular cargo bike and children stroller integrated solution in one vehicle, with minimal operational effort and zero assembly required from a rider to shift from cargo bike mode to an indoor strolling mode. This solution opens up possibilities for delivery companies, electricians and plumbers, families with kids to operate with 100% “Door to Door” green logistics solution.

Furthermore, the cargo bike frame of the present invention may also be modified in particular ways in order to save space, enable easier conversion, and specifically to allow for transport of children in a safer manner by having its handlebars set back a distance from the main steering beam. This has the joint effects of allowing full 34 degree turns without risk of hitting a child who may be being transported in an attached cargo cabin and secondly of providing a natural space behind the steering beam of the cargo bike frame where the components of a second module may fit when the cargo bike is converted to a stroller mode.

Thus, according to a second aspect of the present invention, there is provided a cargo bike frame section, comprising: a cargo cabin support frame, one or more front wheel axel fittings; a steering system comprising a rotatable vertical steering beam configured to change the angle of the one or more front wheel axel fittings upon rotation about its vertical axis, and a rotatable handlebar configured to cause the steering beam to rotate about its vertical axis; wherein the axis of rotation of the handlebar is offset a distance of at least 10 cm rearwards from the axis of rotation of the steering beam.

Finally, the unique structure of the modular cargo bike described herein can be utilized to even greater advantage when used with a novel, specialized cargo cabin which is shaped in order to maximize the use of space without interfering with the conversion between modes of the modular cargo bike.

Thus, according to a third aspect of the present invention there is provided a cargo cabin box for a cargo bike, the cargo cabin box having an indent located at the center of its rear wall configured to receive a cargo bike steering beam.

### BRIEF DESCRIPTION OF THE DRAWINGS

Various embodiments of the invention are disclosed in the following detailed description and accompanying drawings.

FIG. 1 illustrates a side view of the cargo bike frame of the present invention in a closed (lower illustration) and open (upper illustration) position, fitted with wheels and a cargo cabin.

FIG. 2 illustrates a side view of the cargo bike frame of the present invention in a closed (upper illustration) and open (lower illustration) position, fitted with wheels but no cargo cabin attached.

FIG. 3 illustrates first and second views of the cargo bike of the present invention in the open position of FIG. 1 and references how the construction of the frame allows for various industry standard size parts to be fit to the frame.

FIG. 4 illustrates an embodiment of the first module or rear part of the bike.

FIG. 5 illustrates an embodiment of the second module or front part of the bike.

FIG. 6 (A.1) illustrates an example configuration of the telescopic box of the rear frame module which comprises the female elements of the telescopic tubes (A.2) illustrates a close up of a pin-lock mechanism on the telescopic box according to the present invention which enables a distance between the front and rear modules to be controlled and locked in place (A.3) illustrates the configuration of A.1 with nylon or other friction reducing sleeves (or separators) installed in the female tubes.

FIG. 7 illustrates an underside view of an example configuration of the telescopic tubes of the front and rear frames in a closed position and alongside the other key components of the cargo bike structure.

FIG. 8 illustrates an example configuration of the cargo bike frame showing an embodiment where a backplate is used to restrict the movement of the telescopic tubes and hold them in place.

FIG. 9 illustrates an exemplary configuration of a steering system for the front part of the frame.

FIG. 9A shows a number of different views of an example configuration for the steering system of the cargo bike frame of the present invention.

FIG. 10 illustrates an exemplary configuration of the front frame section where the two lower telescopic tubes, as well as two centrally placed tubes at a higher level for structural support of the cabin frame foundation and steering frame foundation, are connected at the front edge of the bike to a master plate metal.

FIG. 11 illustrates an exemplary configuration of a frame hand lock system for controlling the pin-lock system of the cargo bike frame and which is compatible with the cargo bike frame of the present invention.

FIG. 11A illustrates the various components of the pin-lock mechanism in action alongside the hand lock mechanism for inserting and retracting the pin.FIG. 12 illustrates an example configuration of a suspension system that may be fit onto the front module of the cargo bike frame of the present invention. It is shown in a closed frame mode.

FIG. 13 illustrates an example configuration of a steering beam offset from the handlebar steering system in order to accommodate a cabin structure without interfering with the steering mechanism.

FIG. 14 illustrates an alternative embodiment of the cabin structure compatible with the steering system of the present invention.

FIG. 15 illustrates an example configuration of the cargo bike frame of the present invention wherein the rear wheel hubs of the rear module have been fitted with stride pedals to accommodate a rider while being driven by a mid-drive engine.

FIG. 15A illustrates the stride pedals in both folded (upper image) and open (lower image) modes and provides a clear indication of how the stride pedals remain unobstructed by having no vertically overlapping components even when the cargo bike frame is compressed down into a full closed mode of 1200 mm.

FIG. 16 illustrates an example configuration of a pair of stride pedal units which would be compatible with the cargo bike frame of the present invention and the fittings that would allow them to be attached to the frame, as well as an additional fold lock mechanism for ensuring that the strides stay folded and locked in place to reduce the risk of them dropping out inconveniently.

FIG. 17 illustrates an example set of stride pedals having been installed on the cargo bike frame of the present invention using an example fitting.

FIG. 18 illustrates

FIG. 19 illustrates various alternative commercial applications of the cargo bike frame of the present invention, both in unfolded (upper image) and folded (lower image) positions.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

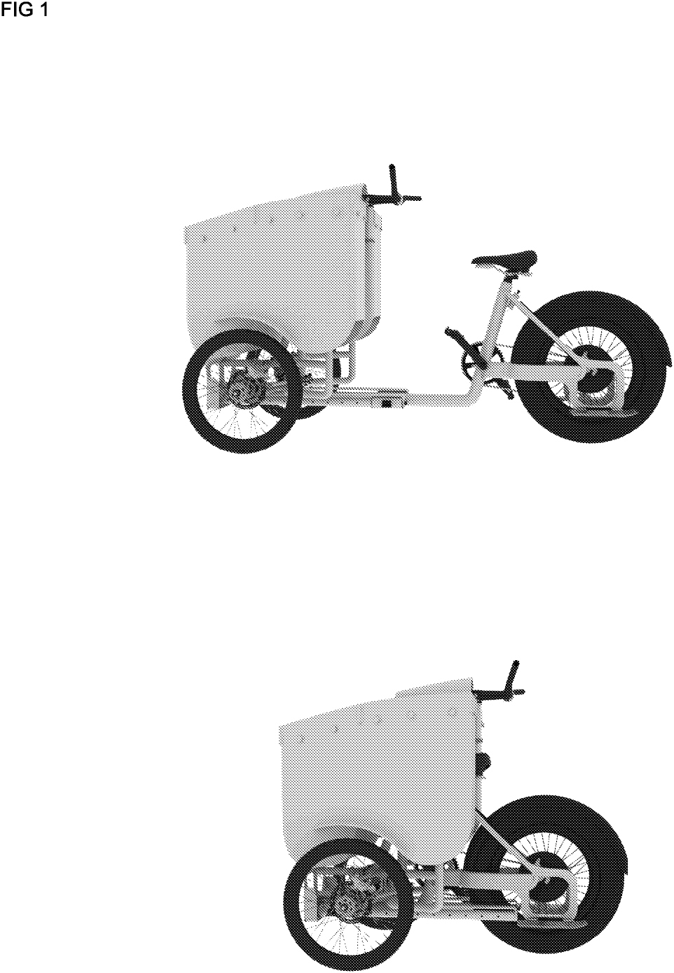

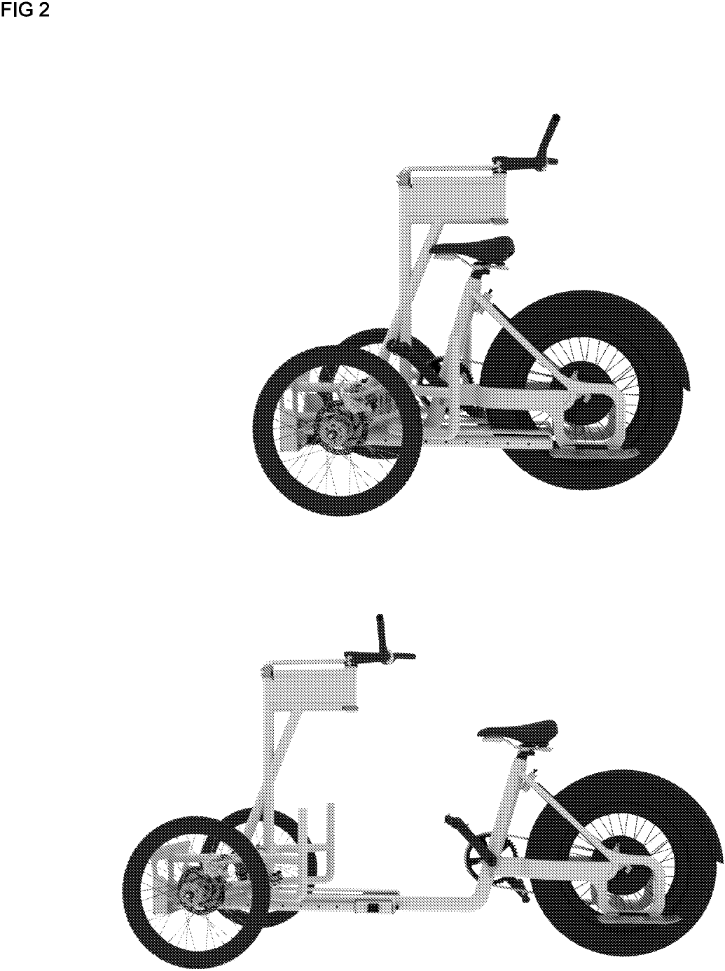

Referring to FIGS. 1 and 2, example embodiments of the cargo bike frame of the present invention are illustrated with wheels fitted to the frame.

FIG. 1 in particular shows a side view of the cargo bike frame of the present invention in a closed (lower illustration) and open (upper illustration) position, fitted with wheels and a cargo cabin whereas FIG. 2 shows the cargo bike frame which is fitted with wheels but no cargo cabin attached.

The illustrated modular structure has the effect that the bike components such as, in this example embodiment, the rear wheel, the pedal & gear system, steering & suspension system, the front wheels, and the front cabin, are able to shift from one position and distance relative to one another without disassembly. In the “closed” position described above where the cargo bike is shortened to the minimum possible length, the front part & the rear part may overlap each other without losing the essential functions of the maneuverability ability of the bike and the stroller such as the steering capability at all time, and also without losing the front cabin space and the carrying capability.

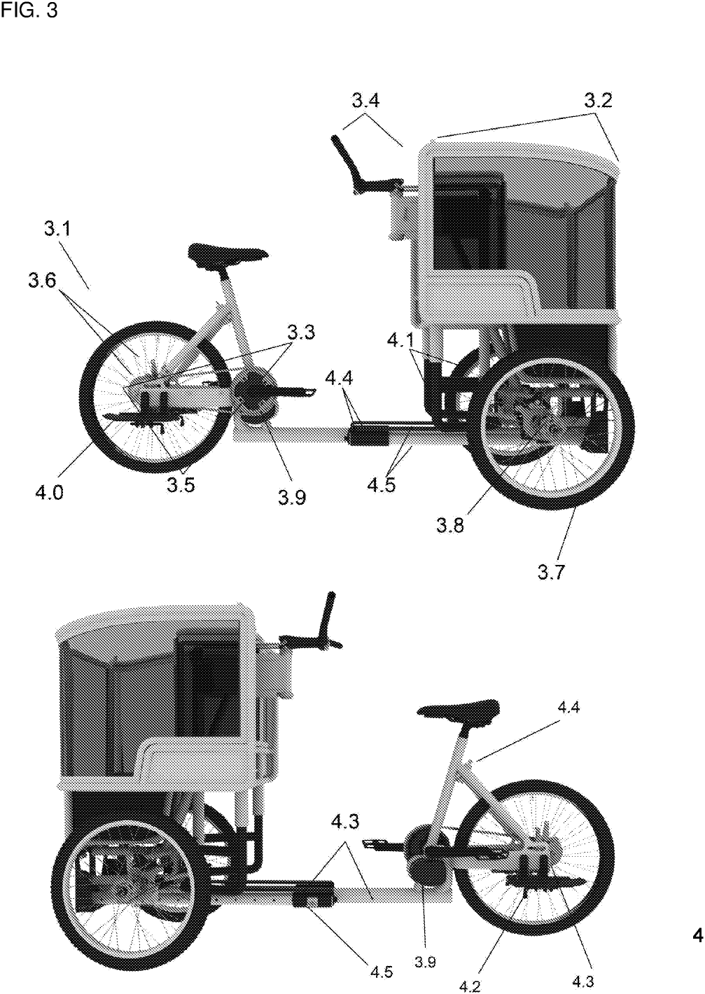

As mentioned above, the construction of the cargo bike frame of the present invention enables compatibility with industry standard sized bicycle fittings. This is further illustrated, referring to the example assembly of FIG. 3 which is fitted with the following parts:

3.1 A rear-wheel in size of up to 26 inches. 3.2 - up to 800 mm length front cargo cabin capable of carrying up to 2-3 children or any other cargo and yet be able to enter elevators, trains, door passages. 3.3 A standard crankset that includes a “bottom crankset”, a “crank spindle”, and gear set that can fit to the rear frame tube from most known brands based on the bicycle industry standards. 3.4 A standard stem and steering handlebars that can fit the invention extended steering rod. 3.5 The standard length required for a bike chain of 400 mm from the crank pedal center to the rear drop out wheel position center point. 3.6 An extra extended distance between the two support tubes for the rear wheel which provides the rear center wheel hub with up to 140 mm in width. This space capacity enables the user to choose any gear set brand on the market including most derailleur sets types on the market today. 3.7 Standard 20″ front wheels. 3.8 Standard disk brakes & wheel hubs. 3.9 A standard Mid-ride electric assistant engine unit (working according to the EU standard 15194 requirements for electric bicycles).

The rear frame can be fitted with a mid-drive engine 3.9 as illustrated or could alternatively be fitted with a rear hub engine thanks to the extended support tubes on the rear wheel 3.6, or alternatively can perform with no engine unit at all and by the power of the pedals alone. Further illustrated are a set of foldable stride pedals 4.0 for allowing a rider to stand on the bike if using an engine for propulsion. In the upper illustration the stride pedals 4.0 are in a folded position which prevents them from obstructing the rider when pedaling.

The stride pedals are designed to drop out from a dropout unit of the rear wheel hub 4.0B, rotating from a folded position out into a 90 degree angle for a user to stand on, this is illustrated by 4.0 in the lower image of FIG. 3 The rider can thus ride in a standing mode anywhere from fully closed mode frame 1200 mm in length up to open mode frame fully 1950 mm and anywhere in between, without impairing any of the functionalities of the bike as a whole. Generally, the cargo bike frame is configured with two stride pedals - one for each side of the rear hub.

4.1. The rear tube front dual telescopic head. This component is key as it provides the supporting structure for the telescopic tubes parallel motion and thereby enables the rear frame-group to slide to the closed mode while allowing the two front telescopic tubes to remain either side of the center line. 4.2. The two front telescopic tubes from the front frame-group enable the foundations for the rear frame-group to be shifted from fully open mode 1950 mm to a full closed mode 1200 mm. 4.3. The rear frame-group lower main tube, which is connected to and supports the rear front dual telescopic head and provides the passage of the rear frame-group main lower tube to access as a single tube in the bike center and access to a fully closed mode of 1200 mm. 4.4. The pin lock “hand trigger” device, which is connected to the pin-lock mechanism and is designed to retract the pin lock piece from the side of the telescopic tubes when the hand trigger is pulled and thereby allow the telescopic tubes of the rear and front modules to slide back and forth with respect to each other.

The pin lock hand trigger is positioned, in the present example, below the rider saddle seat position, and enables the rider to easily unlock the length changing capabilities of the cargo bike frame without needing to leave their seat. This can be particularly useful for riders who do not have a lot of physical strength as they have the leverage of the saddle support to help them pull the hand trigger 4.4. In alternative embodiments not illustrated here, the pin lock hand trigger can also be like a hand brake mount on the front steering frame section. This will be described in detail below.

There are a number of features of the cargo bike frame of the present invention which enable the advantageous effects described above. In particular, the engineering mechanisms created to solve all the challenges of prior art cargo bikes while keeping it seamlessly integrated are as follows:

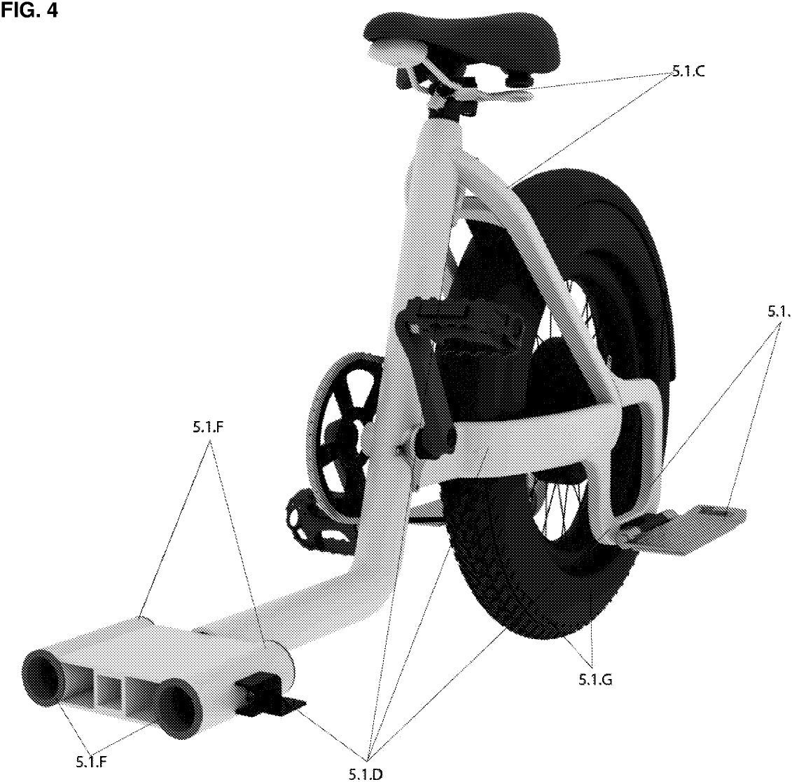

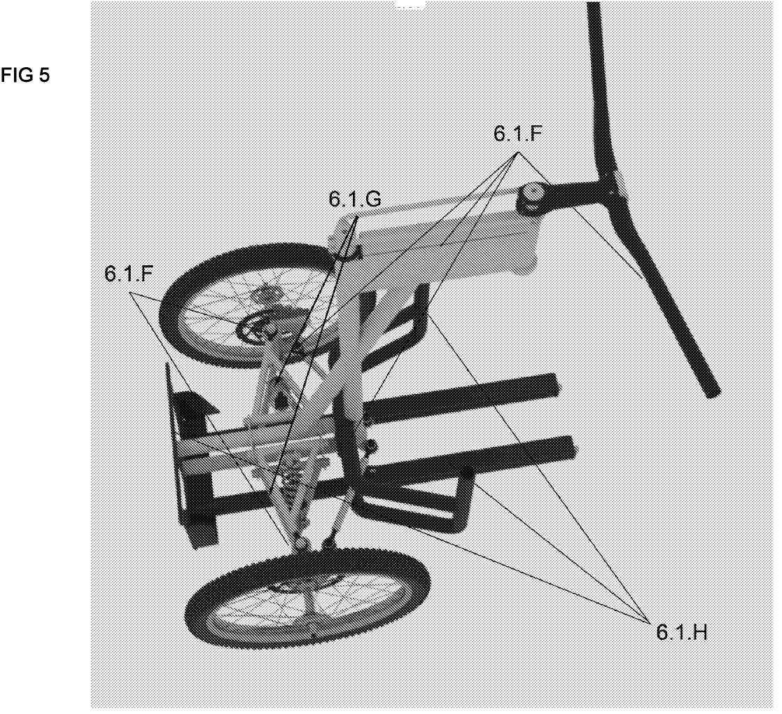

In order to solve the problem of providing capability to shift from an open mode to a closed mode without the need of any disassembly, the cargo bike frame is separated into two main parts or modules. These parts or modules are illustrated separately in FIGS. 4 and 5, respectively.

Referring to FIG. 4, an illustrative embodiment of the first module or rear part of the bike is shown which includes: 5.1.B. The rear wheel & frame foundation. 5.1.C. The rider seat post and seat foundation. 5.1.D. The gear set, crankset, chainset, frame lock system 5.1.F. The dual telescopic extensions, the inner Nylon 6 sliding tubes.

Referring to FIG. 5, an illustrative embodiment of the second module or front part of the bike is shown which includes: 6.1.E. The front frame part. 6.1.F. The front frame foundation for two front wheels. 6.1.G. The front steering system, suspension system 6.1.H. The front cabin foundation.

Advantageously, the cargo bike frame can be fit with any standard industry sized bicycle parts, and can be driven either electrically or by pedals. Thus, the solution of the present invention enables any combination of steering, front suspensions/ front cabin/rear frame units/pedals, and crank unit/Mid-drive engine/rear-wheel/seat group/rear-wheel group gear set/ strides set to work seamlessly together and still be able to reduce down to a total length of 1200 mm, and thus enter most elevators and standard home doors in length and width. Furthermore, the frame is compatible with various engine kit options including mid-ride kits and rear hub kits. If the drive of the bike is 100% electric then the frame may be fitted with a pair of strides for a second user to stand and be transported on the rear frame section.

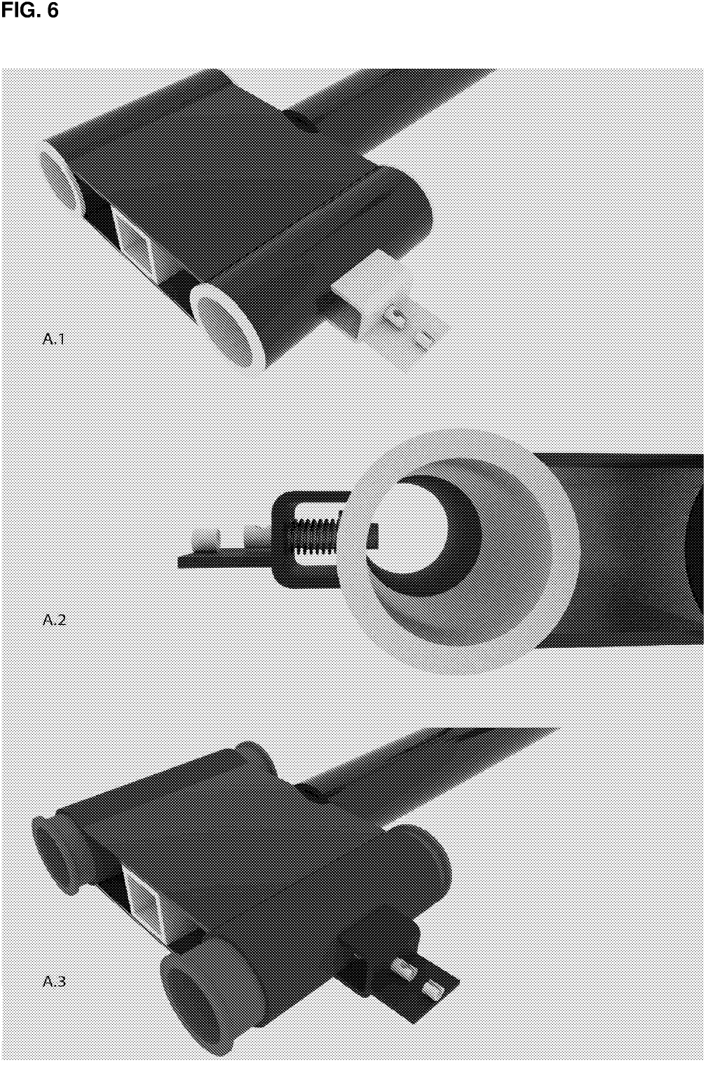

Referring to FIG. 6, (A.1) an example configuration of the telescopic box of the rear frame module which comprises the female elements of the telescopic tubes is shown (A.2) illustrates a close up of a pin-lock mechanism on the telescopic box according to the present invention which enables a distance between the front and rear modules to be controlled and locked in place (A.3) illustrates the configuration of A.1 with nylon or other friction reducing sleeves installed in the female tubes.

The example configuration of the telescopic box of the rear frame module which comprises the female elements of the telescopic tubes is shown. This telescopic box head extension advantageously allows for dual telescopic tubes to pass from the two sides of the rear frame group, but not the center. This ability provides the space for components which may be fit to the rear frame section such as, for example a pedals set, crankset, chainstay, seat stay, seat tube, saddle, rear-wheel, and gear group to pass in the middle between the two front telescopic tubes without losing the conventional shape and width of the crankset that has a standard width size. Thus a rider is not inconvenienced when pedaling due to the optimization of space on the cargo bike frame.

For the rear wheel frame (first module) to move forward and parallel to the front frame (second module) and thereby reduce the total length of the cargo bike to a length that is easily maneuverable indoors a rear frame comprising an extension tube telescopic box head is provided with a single rear frame tube in the center of the box for one rigid unit. The box of the rear frame further comprises female telescopic tubes, which may have inner Nylon6 coating or inner tubes (separators) (see A.3) for smooth sliding, on each side to the rear main frame rigid tube. The rear extension telescopic tubes are connected to a set of male telescopic tubes extending from the lower part of the front cargo bike frame or second module.

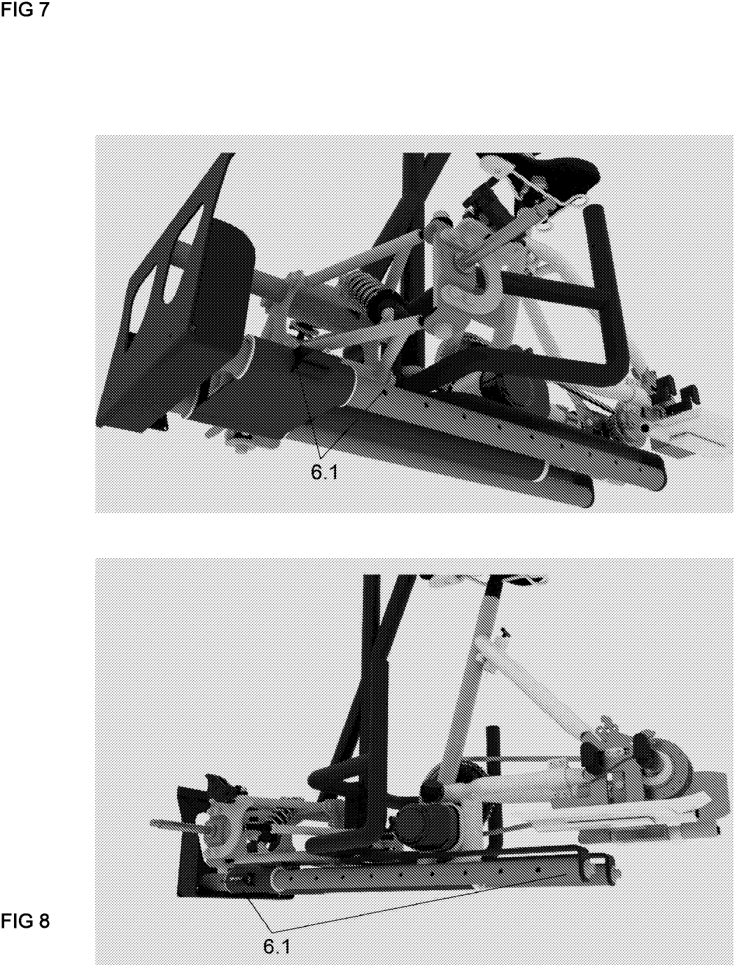

Referring to FIG. 7, an example configuration is shown of the telescopic tubes of the front and rear frames and the other parts of the front frame such as the suspension and steering systems. 6.1: The two telescopic tube elements of the first and second modules are positioned at the bottom of the frame to go through the steering system and the suspension system in which position right above them.

That is, the multi height tiered frame allows the entire back frame to be smoothly slide into and under the front frame and the front cabin units with full compatibility that does not compromise any of the vital functions such as steering handle, the front suspension, the baggage or the kits while converting the bike to a stroller/carriage and vice versa back to a cargo bike.

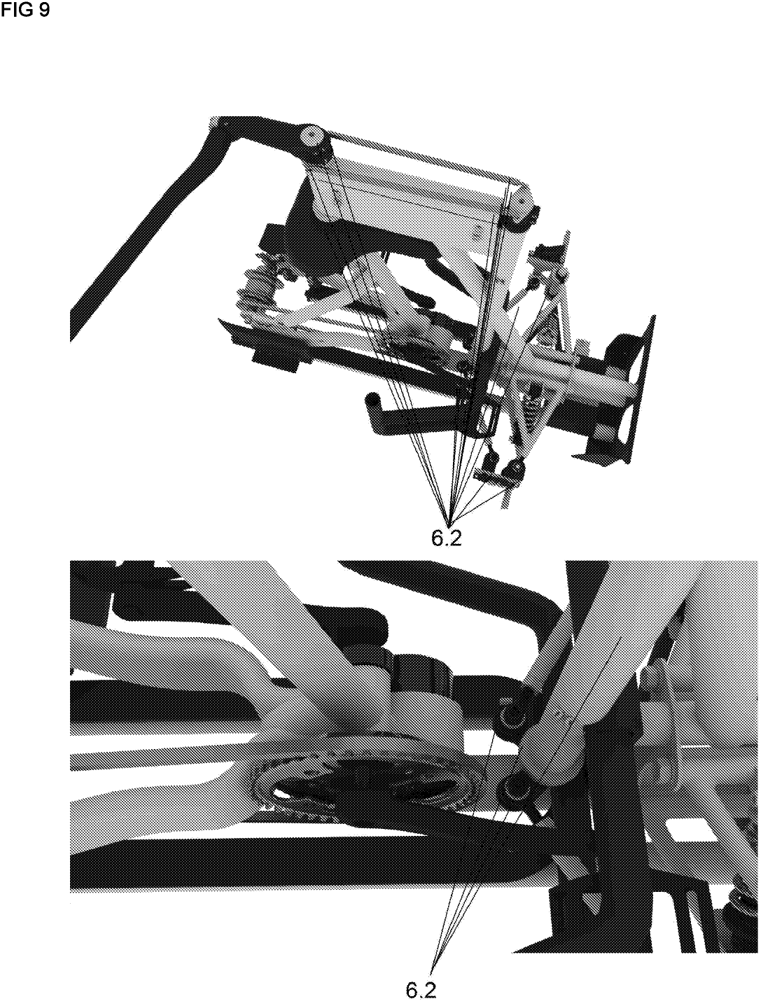

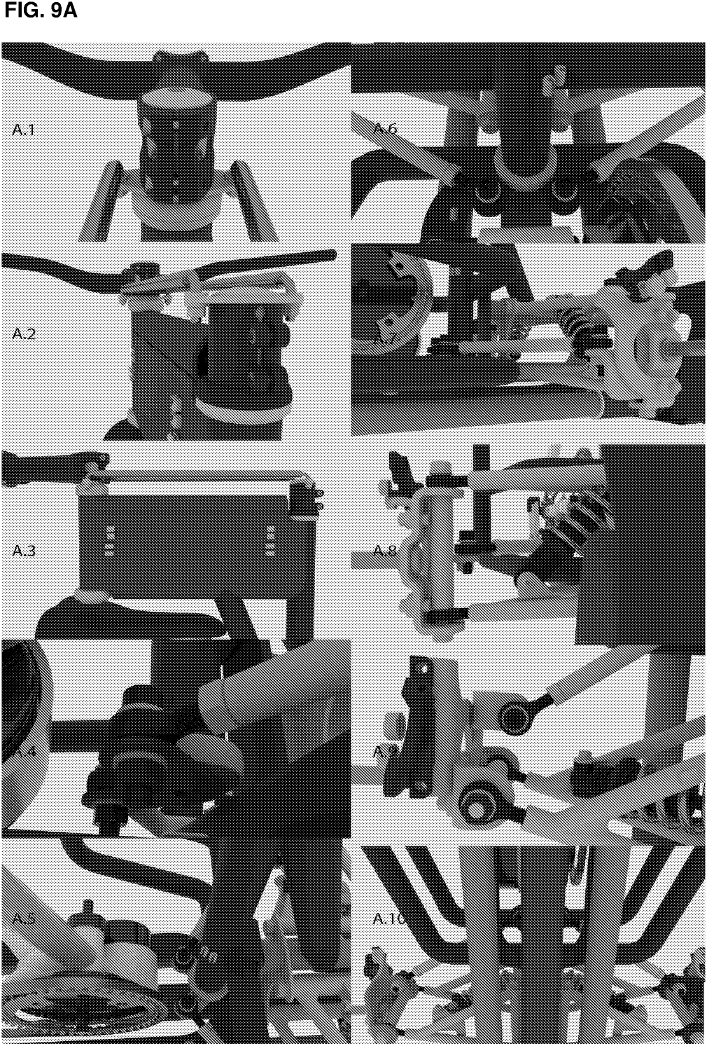

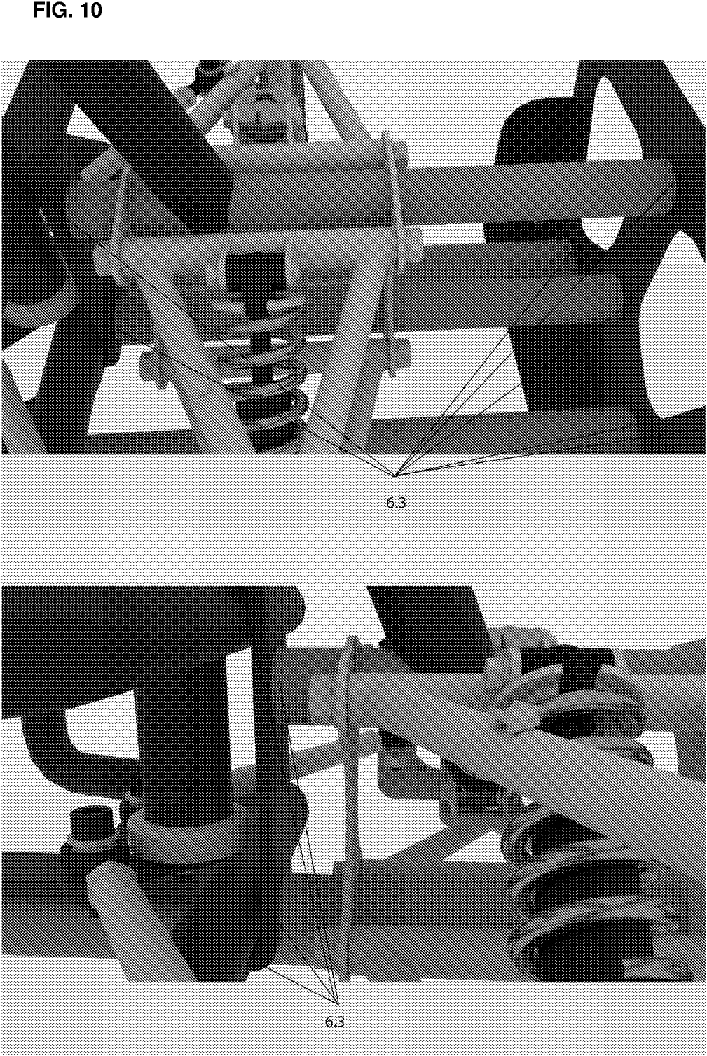

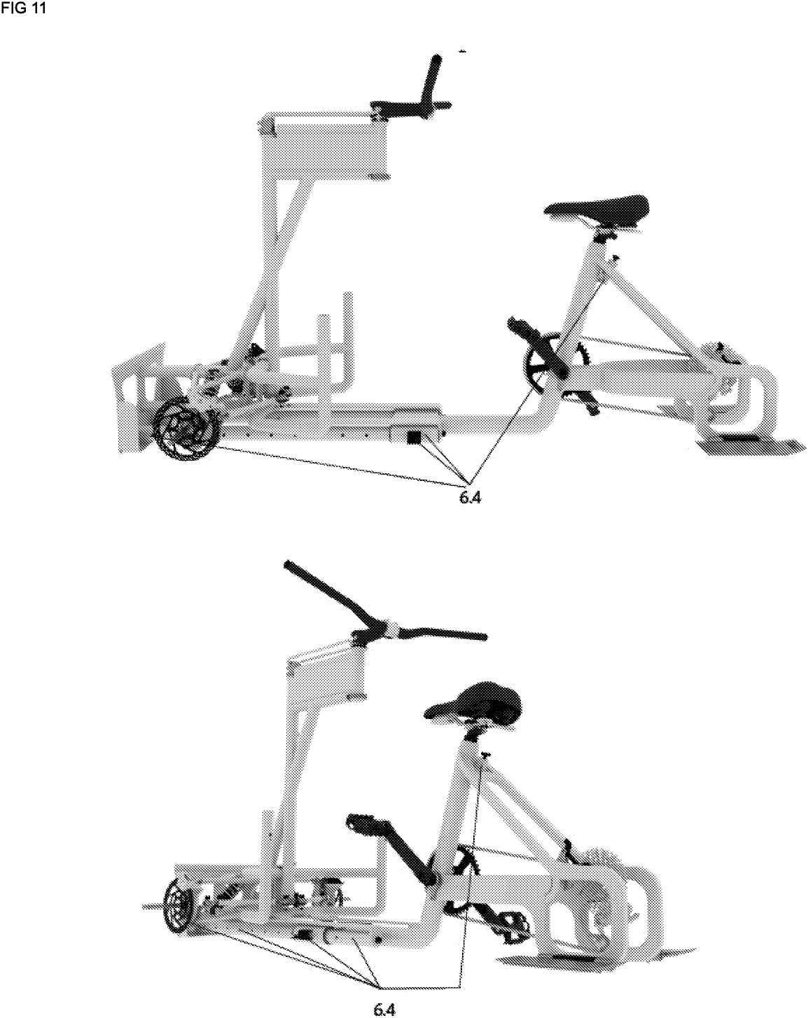

Referring to FIG. 8, an example configuration of the cargo bike frame showing an embodiment where a backplate is used to restrict the movement of the telescopic tubes and hold them in place. 6.1.A. the backplate provides both the border of the rear frame sliding space and the foundation for the front cabin fitting. The backplate can be removed in some examples by removing screws from the front sliding tubes edges, and this way separates the rear frame part from the front frame part, for example for maintenance and parts repairs.

The extent of movement of the tubes is limited by a backplate so the frame can easily change length without the telescopic tubes sliding apart from each other completely. This way the first module, which is the rear frame-group can slide on the double tubes of front frame group and get all the way to the front end of the bike frame without touching all other parts comprised in the front frame such as the suspension system, as these parts are located above the telescopic tube parts of the front frame.

Referring to FIG. 9, an exemplary configuration of a steering system for the front part of the frame is shown.

In this example, above the telescopic tube extending mechanism that connects the rear and front frame is mounted the steering system 6.2. which is connected to the front primary tubes that hold and support the front suspension system. Together these parts control the two front wheels.

FIG. 9A further illustrates exemplary configurations of the steering system components of the fron module.

In particular, referring to FIG. 9A, A.1 shows a view from the front of the cargo bike of the steering beam and axis of rotation being offset from the handlebar steering system, A.2 shows a similar view from a side angle to display the mechanism by which the beam is held offset, A.3 shows a side view of the same, A.4 shows one of the joints of the steering system, A.5 shows how the steering system is linked to the backplate in a closed position, A.6 shows a different angle of the backplate and the steering system, A.7 shows another view form the side of the backplate, A.8 shows the steering system in relation to the suspension system, A.9 shows another angle of the suspension system in relation to the steering system, and A.10 shows the supporting tubes of the front steering system of the fron module.

Referring to FIG. 10, an exemplary configuration of the front frame section is shown where the two lower telescopic tubes, as well as two centrally placed tubes 6.3 at a higher level for structural support of the cabin frame foundation and steering frame foundation, are connected at the front edge of the bike to a master plate metal. The illustrated configuration having the steering and suspension systems mounted to the frame at a higher level in a two-tiered structure allows space for the telescopic tubes to be compressed and for the second module to decrease its distance from the first module without interfering with said suspension and steering systems.

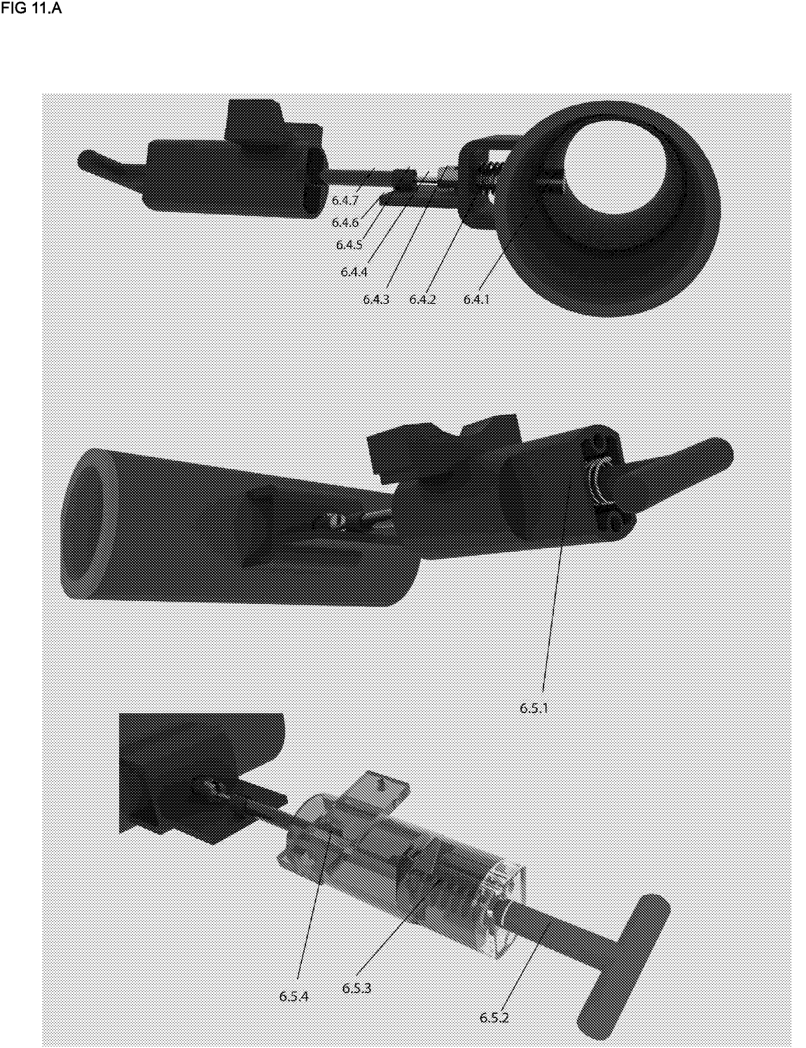

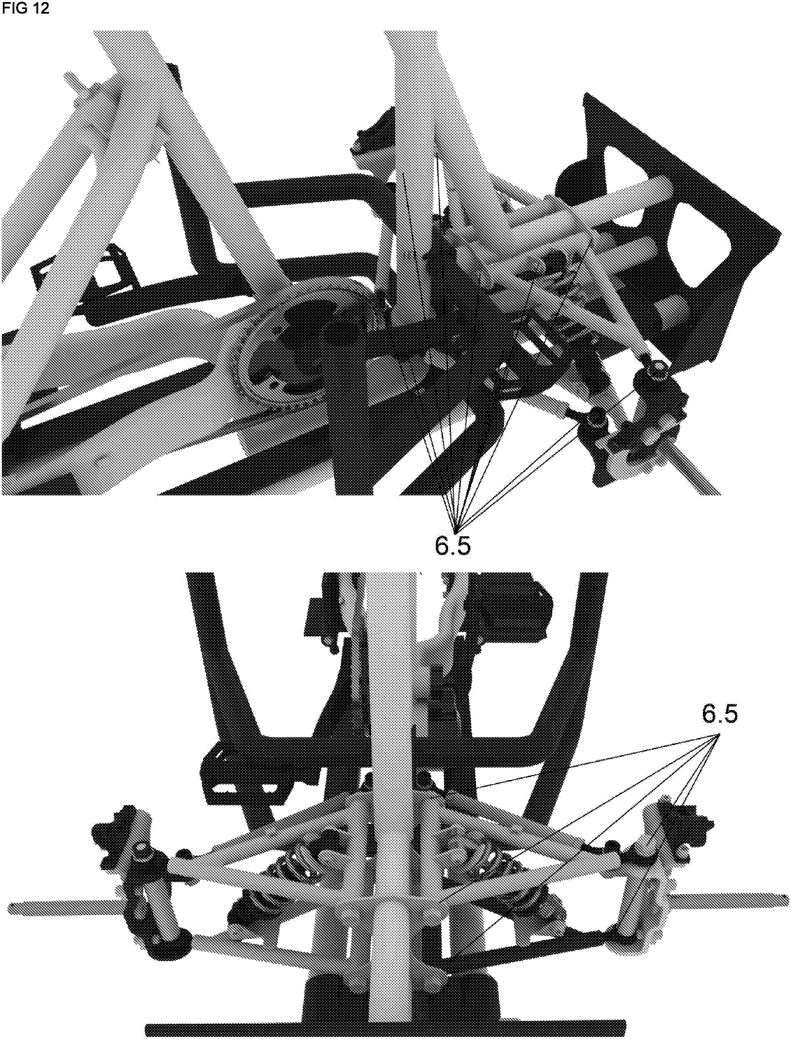

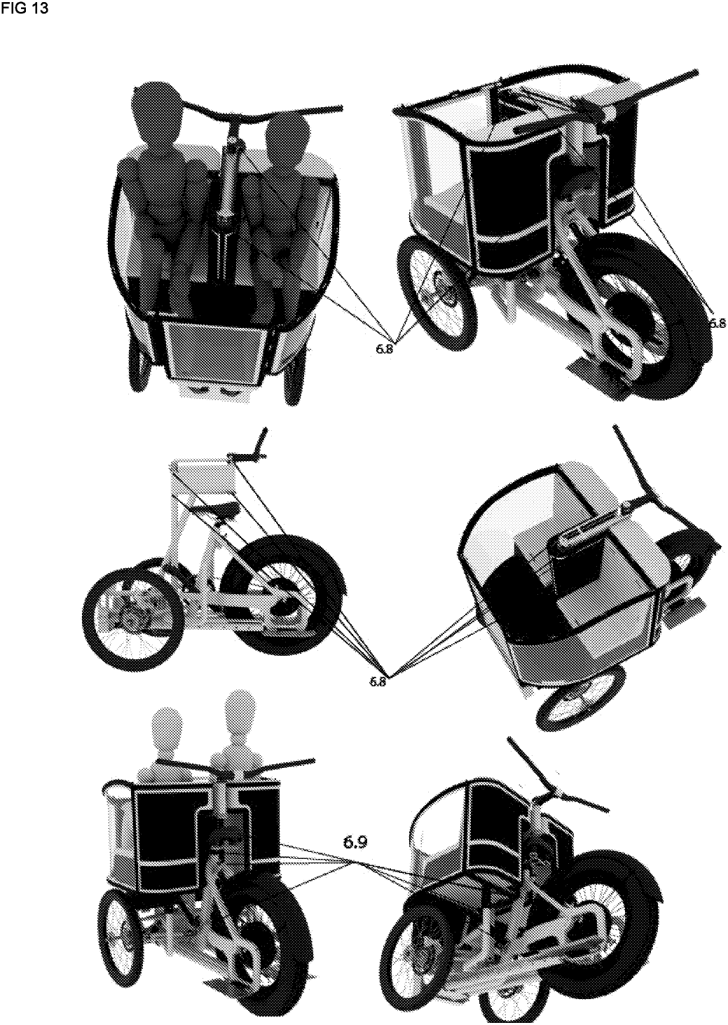

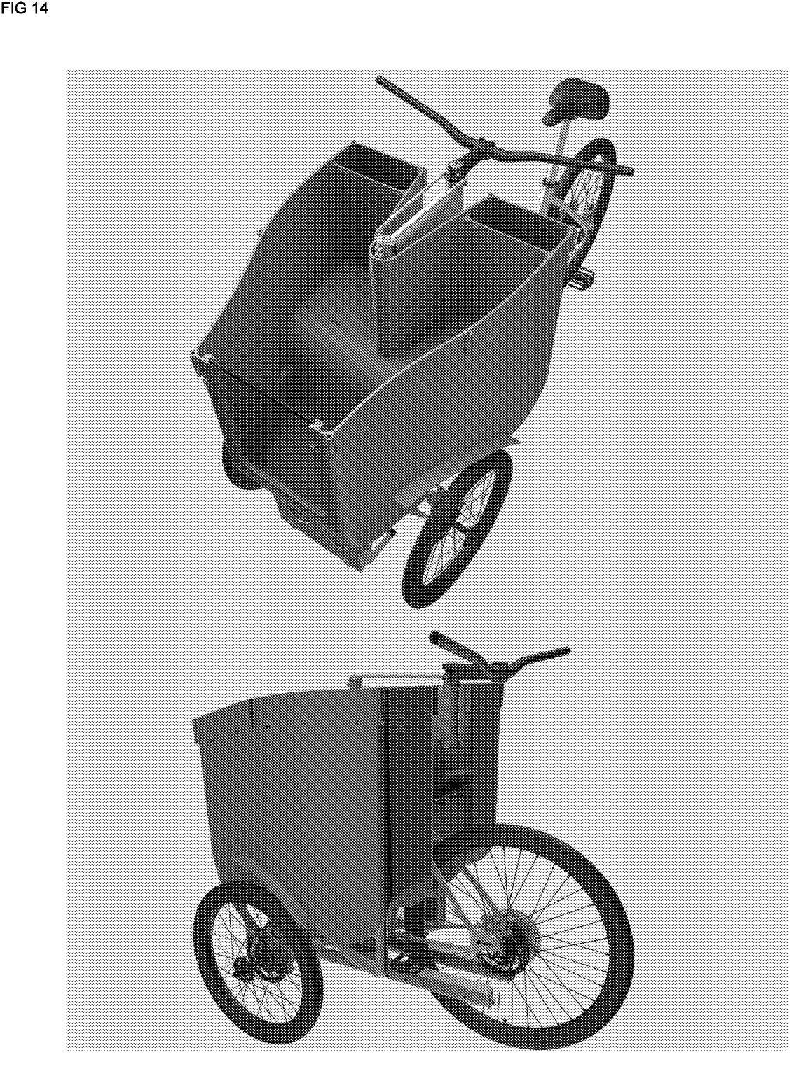

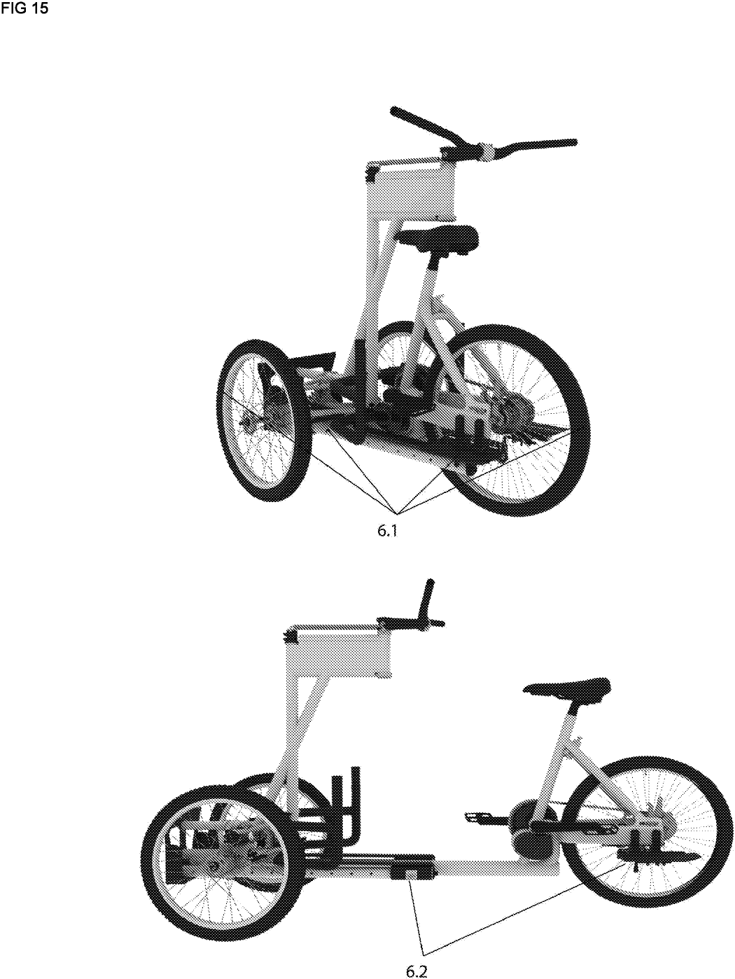

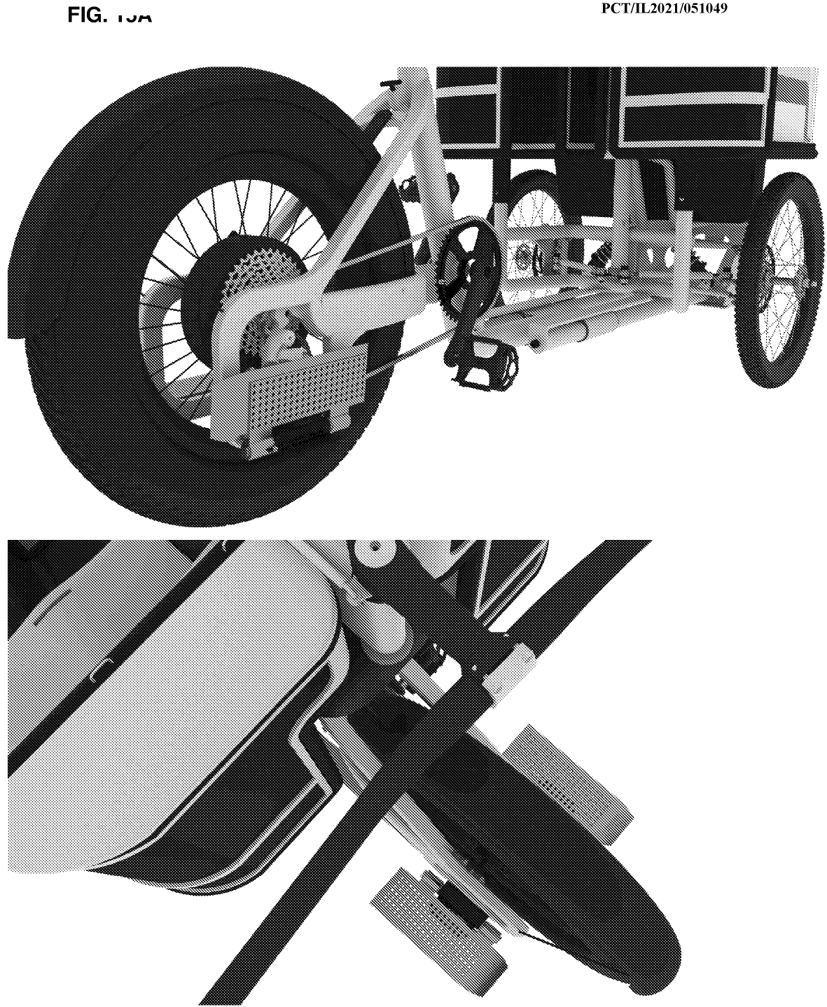

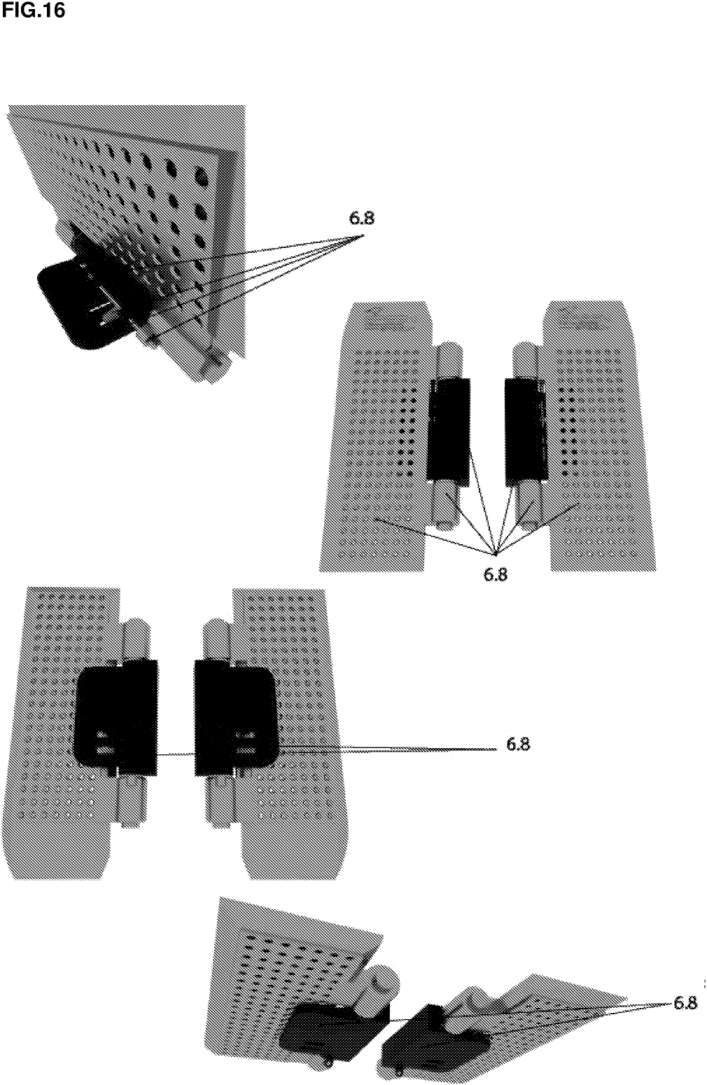

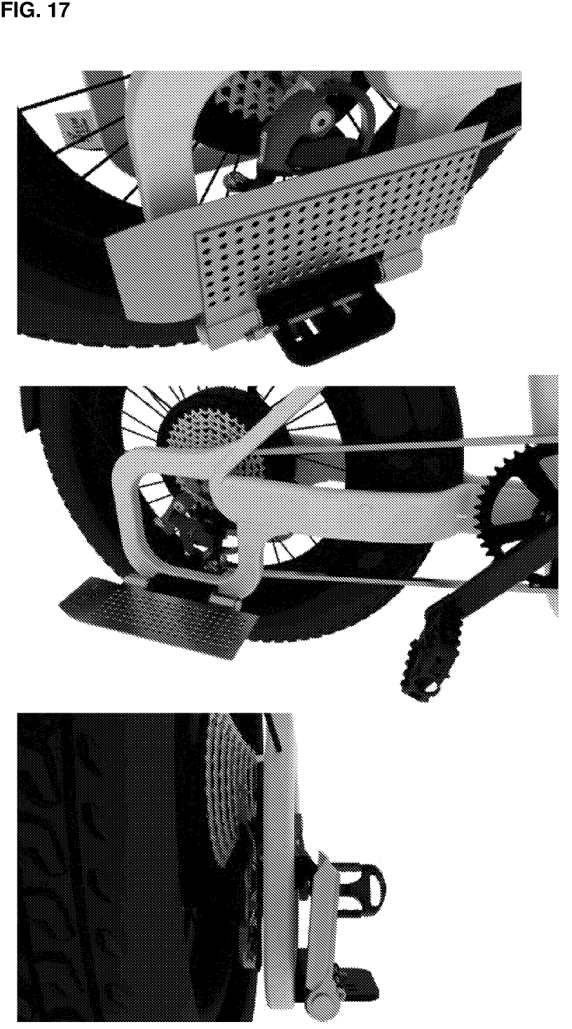

Referring to FIG. 11, an exemplary configuration of a frame hand lock system compatible with the cargo bike frame of the present invention is shown.

In this example, the frame lock system, illustrated by elements 6.4 and 6.4A, takes the form of a pin-lock mechanism, and is positioned on the left extension telescopic tube. This locking mechanism allows a user to control whether or not the female and male telescopic parallel tubes can slide with respect to each other, and is able to lock them in position at a number of set positions relative to each other based on the positions of the pin holes. This can also be used to control the distance of the seat position with respect to the steering handles and thereby adjust for rider height requirements, thereby making the bike frame adjustable for both male and female riders.

In order to make it convenient for a rider to control the pin lock mechanism, the pin lock mechanism may be controlled by a trigger on the handlebars or somewhere else on the bike frame that would be easy for the rider to reach and actuate in a standing position. For example, it can be operated via a handle connected to a Bowden cable & brake arm. When the rider grips or pulls the arm lock directly from the steering handlebars, the steel pin which is connected to the Bowden cable on the telescopic tubes is released form the pin hole against the resistance of a metal spring that is fixed in the lock structure.

When the rider releases his hand from the hand lock arm, the force resisting the metal spring is removed and the pin is free to slot back into a pin hole, which can be the same pin hole or a different pin hole if the rider has adjusted the size of the cargo bike frame by changing the relative positions of the telescopic tubes. Advantageously, with such a locking mechanism installed on the telescopic tubes of the cargo bike frame, the rider can push the rear part from the seat and compress the cargo bike to a stroller size mode or anywhere in between. When the rider releases the lock handle, the pin goes back to the overlapping hole. Thus the bike frame disclosed can be closed and opened immediately and at any length uniformly without unloading cabin/goods/baggage or children at any stage.

Referring to FIG. 11A, various components of the pin-lock mechanism that locks the female and male tubes from sliding with respect to each other 6.4.1 to 6.4.7 are shown (top image) alongside the hand lock mechanism 6.5.1 for inserting and retracting the pin (middle image and bottom image).

The hand lock mechanism uses a spring to resist being pulled out of position easily, but once a user applies enough force to pull the hand lock mechanism out of position, resisting the spring tension, the connected pin that is holding the telescopic tubes in position will be released and the tubes will be free to slide with respect ot each other. As can be seen from the bottom image, in one form the hand lock mechanism can comprise a handle 6.5.2 to be pulled by a rider, a casing 6.5.4 for protecting and holding the spring 6.5.3 in place.

In some embodiments, the pin lock system illustrated herein may be replaced with, for example, electrically controlled telescopic tubes, a cogwheel system, or a lager beer slider. Other modes are also possible.

Referring to FIG. 12, an example configuration of a suspension system 6.5 that may be fit onto the front module of the cargo bike frame of the present invention is shown. As described above, the suspension system is set at a higher level than the telescopic tubes of the cargo bike frame, in this example by having it supported on frame components attached to a master support plate, in order to allow components which overlap when the cargo bike frame is converted into its minimal length “closed” mode from interfering with the suspension system, thereby optimizing space in closed mode whilst retaining functionality. This additionally enables the front wheels to retain industry standard turning ratio and provides the pedals, if the frame is fitted with pedals, to fit below the suspension system in closed mode.

Another aspect of the present invention enables a cargo bike frame to have a cargo cabin mounted to the front whilst still providing full rotational motion of the handlebars for steering purposes without interfering with possible cargo carried in the cabin. This functionality is provided by the feature of an extended steering handle which is offset from the axis of rotation of the vertical steering beam of the cargo bike frame.

Referring to FIG. 13, an example configuration of a cabin structure 6.8 and compatible steering beam which is offset from the handlebar steering system in order to accommodate the cabin structure is shown. The axis of rotation of the steering upper handle in the present example may be offset a distance of 30 cm to the rear of the steering beam.

Furthermore, this allows for an adjustable bike frame solution compatible with all standard accessories parts of the bicycle industry without restricting a user to a particular cargo bike specialized brand.

According to yet another aspect of the present invention, there is provided a specialized cabin 6.8 for optimizing the amount of space in both the open and closed positions of the modular cargo bike frame described above.

Referring to FIG. 13. A, an alternative configuration of the cabin structure is illustrated in position on the cargo bike frame of the present invention. The illustrated alternative cabin structure has additional features including a transparent front facing window set into its front surface an two small cargo carrying pockets set into the rear portions of the cabin that extend behind and either side of the steering beam when mounted upon the bike frame. While specific configurations of the cargo cabin are illustrated herein it should be recognized that any cargo cabin designed with a central indent configured to receive and accommodate the central steering beam of the cargo bike frame could be used and that the illustrated examples are not limiting.

Referring to FIGS. 13 and 14 the cargo cabin 6.8 is designed with an open central indent gap in its rear facing wall which, when fitted to a cargo bike having a vertical steering beam, receives the vertical steering beam in the indent so that the space either side can be used without overlapping too far with the rearward components of the cargo bike when it is in a closed position.

In the illustrated example, the cabin gap measures 10 cm wide (The access part of 6 cm combined with the inner gap wall) and 32 cm long. This way the rear frame part of the cargo bike frame of the present invention can enter under the steering extended steering arm when shortening the frame length down to 1200 mm closed position and yet maintain 800 mm passenger compartment length without losing any of the essential components and 34-degree steering durability of both front wheels.

Advantageously, the cabin of the present invention is versatile and, whilst maintaining the core feature of having a central indent for receiving the vertical steering beam, can be disassembled in seconds and replaced with another such dedicated cabin for any other use of delivery, service, transportation, or any other purpose.

Furthermore, as mentioned above, the cargo bike frame of the present invention is also compatible with mid-drive engine units as well as rear-wheel hub engine units. Advantageously, a mid-drive engine unit can be incorporated while increasing the total length of the frame by no more than 4 cm.

The cargo bike mode to stroller mode conversion functionality is not affected by the inclusion of either mid-ride or rear hub engine assistance, and both of these potential embodiments are compatible with 250 W EU 15194 standard engines. Furthermore, they are compatible with up to 750 W engines in line with the legal regulations of some territories.

There is a substantial difference in the engineering challenges that arise from fitting a mid-drive engine unit that is positioned on the rear Lower main tube to a rear hub/ or no non-electric option and that the frame capable of working with both options with one slide small different yet without to harm any vital function of steering, suspension, cabin, stride standing mode, rider seat position.

xample dimensions for the fully fitted cargo bike frame fitted with mid-ride, rear hub, and without any engine unit are as follows: a frame fitted with a mid-ride engine unit can close down to 124 cm and with 24″ rear wheel; a frame fitted with a rear hub engine unit can close down to 120 cm and with 26″ rear wheel, a frame fitted with no engine unit can also close down to 120 cm and with 26″ rear wheel, down to 118 cm with a 20″ rear wheel, and down to 116 cm with an 18″ rear wheel.

Additionally, as mentioned above, the cargo bike frame of the present invention can not only shorten from a total length to a minimum length, for example of 1950 mm to 1200 mm, but due to the construction of the telescopic tube system, can also be locked to a total length anywhere between the maximum length and minimum length. This advantage becomes particularly important in embodiments where the cargo bike frame of the present invention is fitted with a mid-drive engine and stride pedals for a user to stand on the rear module.

The cargo bike frame of the present invention is constructed so that when the rear module is fitted with stride pedals, such as for example on the rear wheel hubs of the frame, on which a rider may stand, the stride pedals do not vertical overlap with any other cargo bike frame components regardless of the position of the telescopic tubes with respect to one another. That is, a rider may stand on the stride pedals when the cargo bike frame is in closed mode, open mode, or anywhere in between.

Referring to FIG. 15, an example configuration of the cargo bike frame of the present invention is shown in both open and closed modes wherein the rear wheel hubs of the rear module have been fitted with stride pedals.

As can be seen, with the illustrated design of the cargo bike frame the stride pedals are unobstructed in both the closed mode (upper image) and the open mode (lower image) and this shows that on all modes, the strides can perform with a person in a standing mode, because the strides do not vertically overlap with any other components even at minimum length position of the frame.

FIG. 15A illustrates the stride pedals in both folded (upper image) and open (lower image) modes and provides a clear indication of how the stride pedals remain unobstructed by having no vertically overlapping components even when the cargo bike frame is compressed down into a full closed mode of 1200 mm.

That is, even though the components like the chainstay (for in the present example the stride pedals have been fit onto an embodiment of the cargo bike frame which is propelled by pedals) are pressed right up against the backplate of the front module, there is still clearly enough room for a user to stand on the stride pedals without obstruction.

Referring to FIG. 16, an example configuration of a pair of stride pedal units which would be compatible with the cargo bike frame of the present invention is shown.

The strides pedal units are configured with a “drop out” mechanism that allow them to open to 90 degrees from the rear wheel hub on which they are fitted and above the side’s telescopic tubes of group 2 without interruption with any other groups or the lower telescopic tubes at any point.

The stride engineering design that enables the strides to be compatible with the cargo bike frame in all modes and to correspond to the lower telescopic tubes is based on a strides foundation unit as part of the “drop out” left and right groups of the rear wheel hub and which connect to the chainstay and the seat stay.

As can be seen from the figure, various fitting mechanisms 6.8 may be used to rotatably connect the stride pedals to the cargo bike frame.

Additionally, in the lower image, a fold lock mechanism is shown built into the stride pedal fittings to allow a user to lock the strides into a folded position when not in use and ensure that they do not inconveniently drop out. The fold lock mechanism may for example be a spring-based pin lock mechanism. Each stride pedal unit is fitted with such a lock mechanism and therefore should be locked into folded positions individually.

Also shown in this figure is a modification to the cargo bike frmae of the present invention in order to accommodate the use of the stride pedals. That is, instead of being a hollow tube, the chainstay is in the form of a long, solid bar which can therefore support the weight of a user, since the user’s weight would be transferred from the stride pedals and thereby put a great amount of weight pressure on the chainstay.

The principles described above in relation to the stride pedals are also true for embodiments where the cargo bike of the present invention is fitted with a rear wheel hub drive engine or no engine at all.

Referring to FIG. 17, an example configuration of a complete set of stride pedals having been installed on the cargo bike frame is shown.

It is important to understand the versatility that the combination of these pedals and the adjustable length of the bike provide the user with.

Not only can the bike frame adapt ergonomically to the height and arm length requirements of users of different sizes and body shapes, but the frame allows seamless transition between different “modes” of transport.

These modes of transport fall into a number of categories:

Stroller mode: as referred to herein, stroller mode refers to the frame being fully closed (retracted) and the rider pushing the bike forward using their own kinetic energy as they walk while holding and steering via the steering handles. Stroller mode is very convenient for carrying children in the cargo cabin.

Scooter mode: as referred to herein, scooter mode refers to the rider propelling the bike forward via a motor while steering with the handles. In scooter mode, the rider can rest their feet on the stride pedals comfortably and can either stand or rest on the seat of the rear module. If standing, the rider can have the bike in a semi-closed configuration to shorten the length of the frame.

Bike mode: as referred to herein, bike mode refers to the user resting their weight on the seat of the rear module and propelling the bike forwards by pedaling as with a normal bike.

Furthermore, in any one of these modes where the rider themselves are not standing, they can accommodate a passenger behind them who stands on the stride pedals themselves.

In some embodiments, a second seat may even be provided behind the main seat to accommodate a passenger while the rider stands on the stride pedals, it is also possible to include a second set of stride pedals.

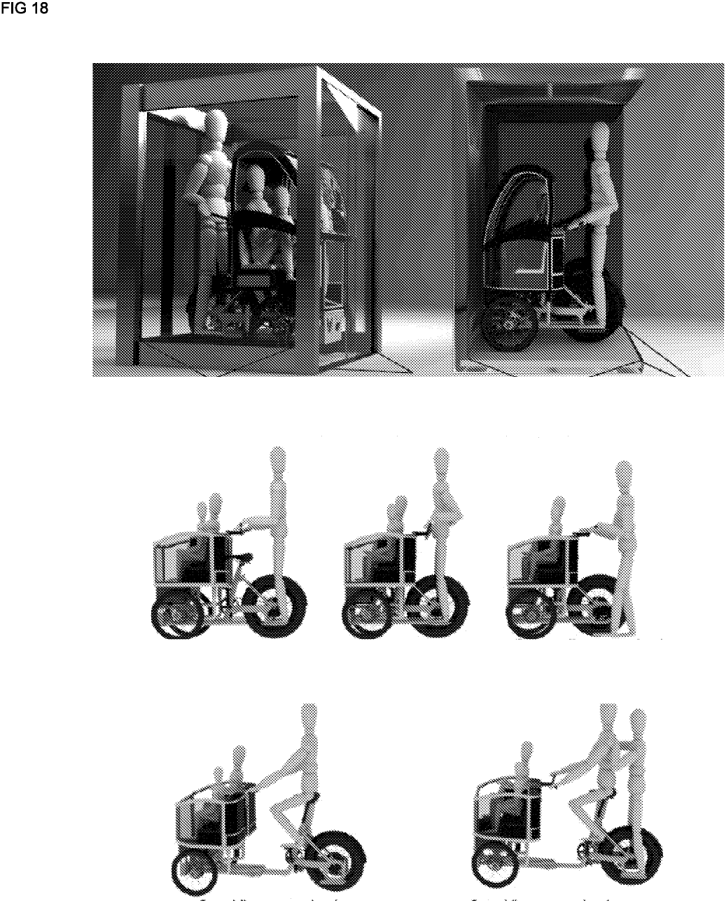

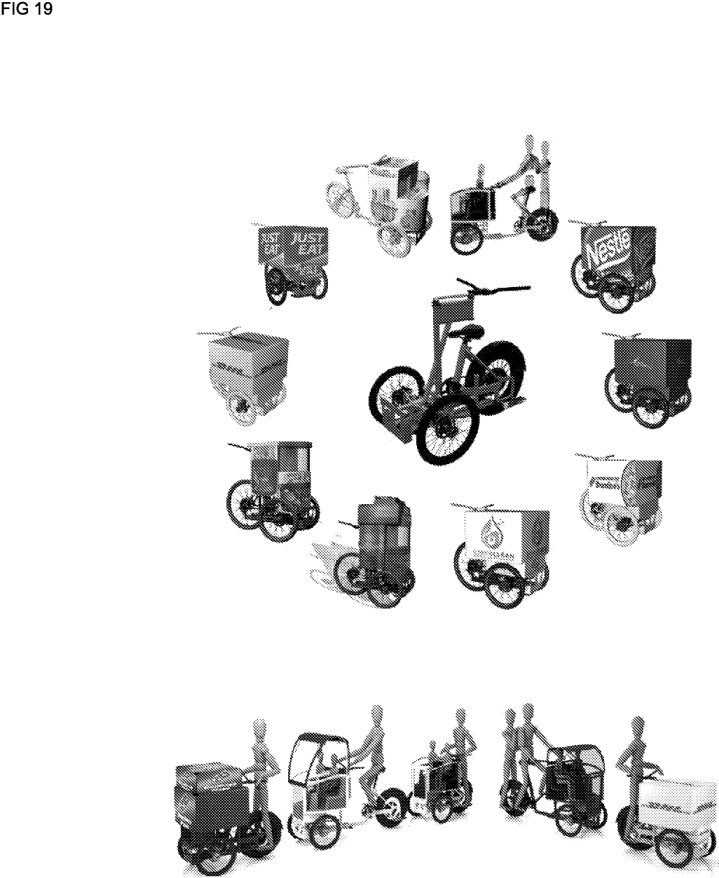

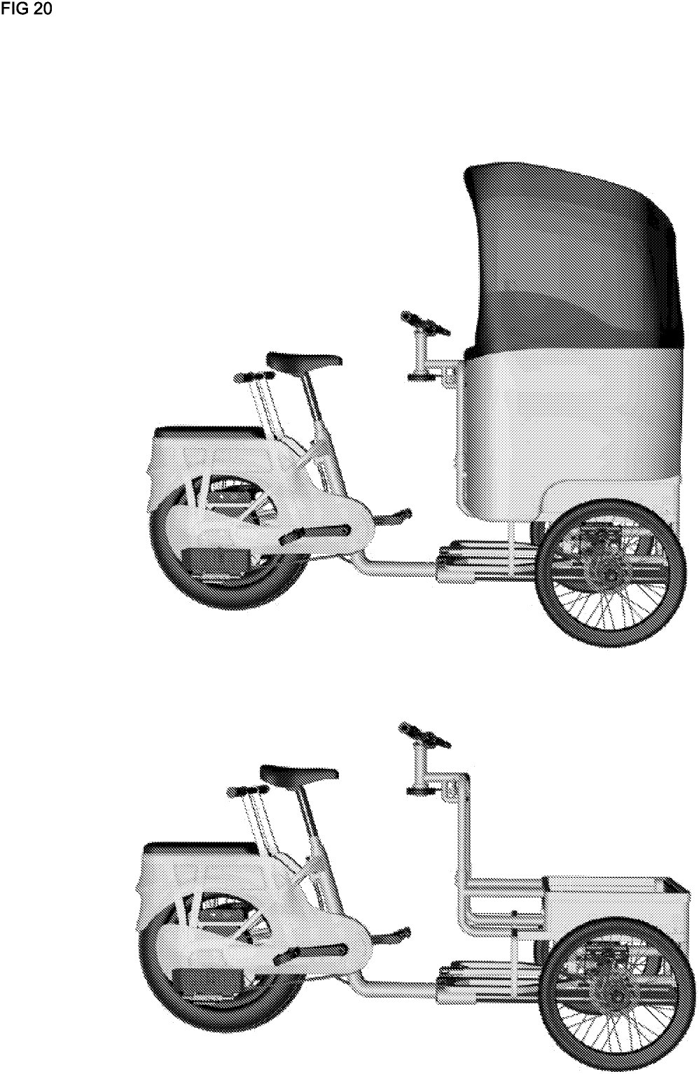

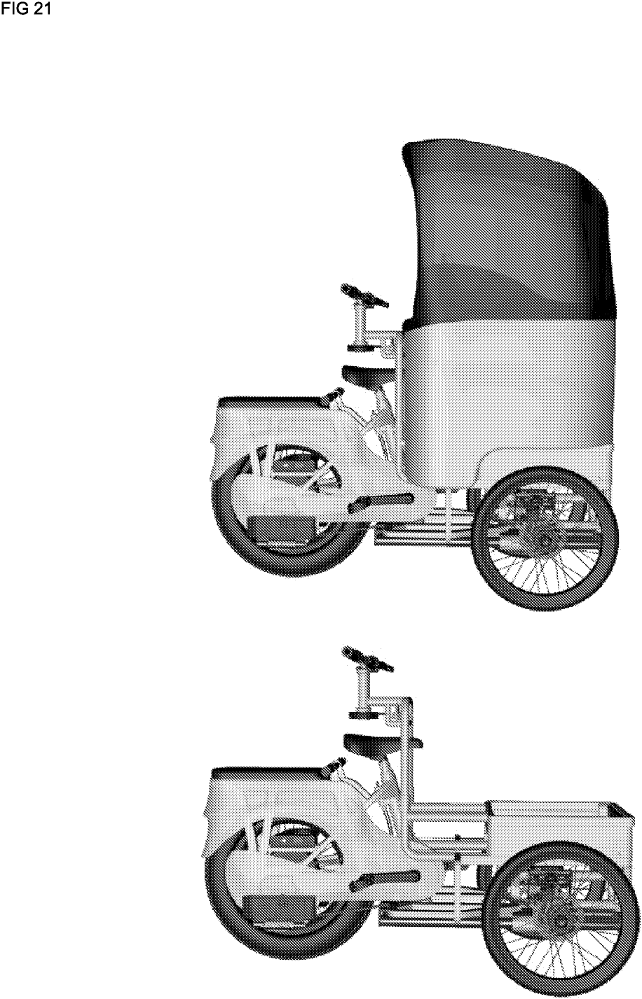

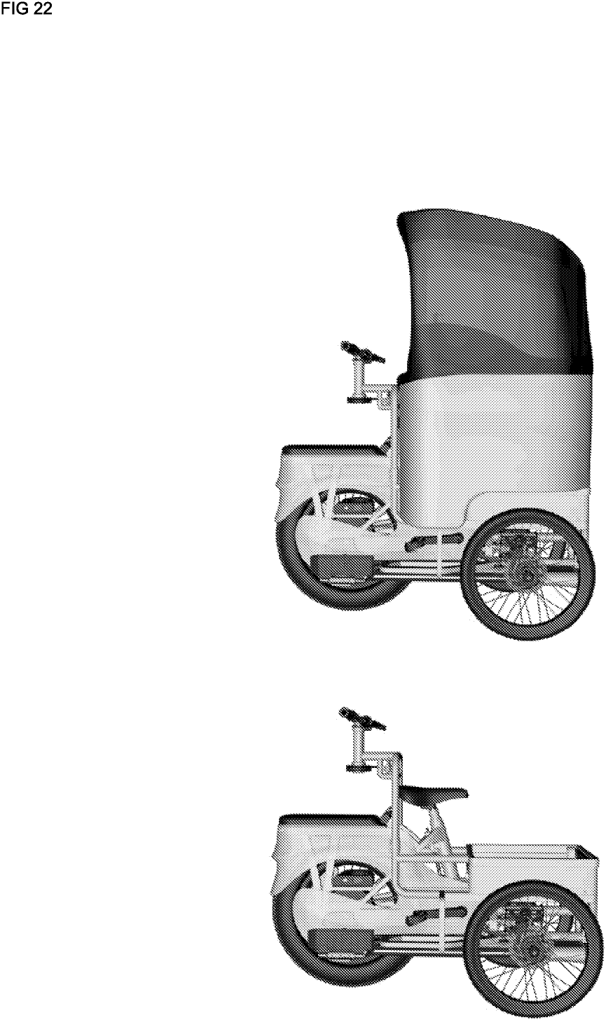

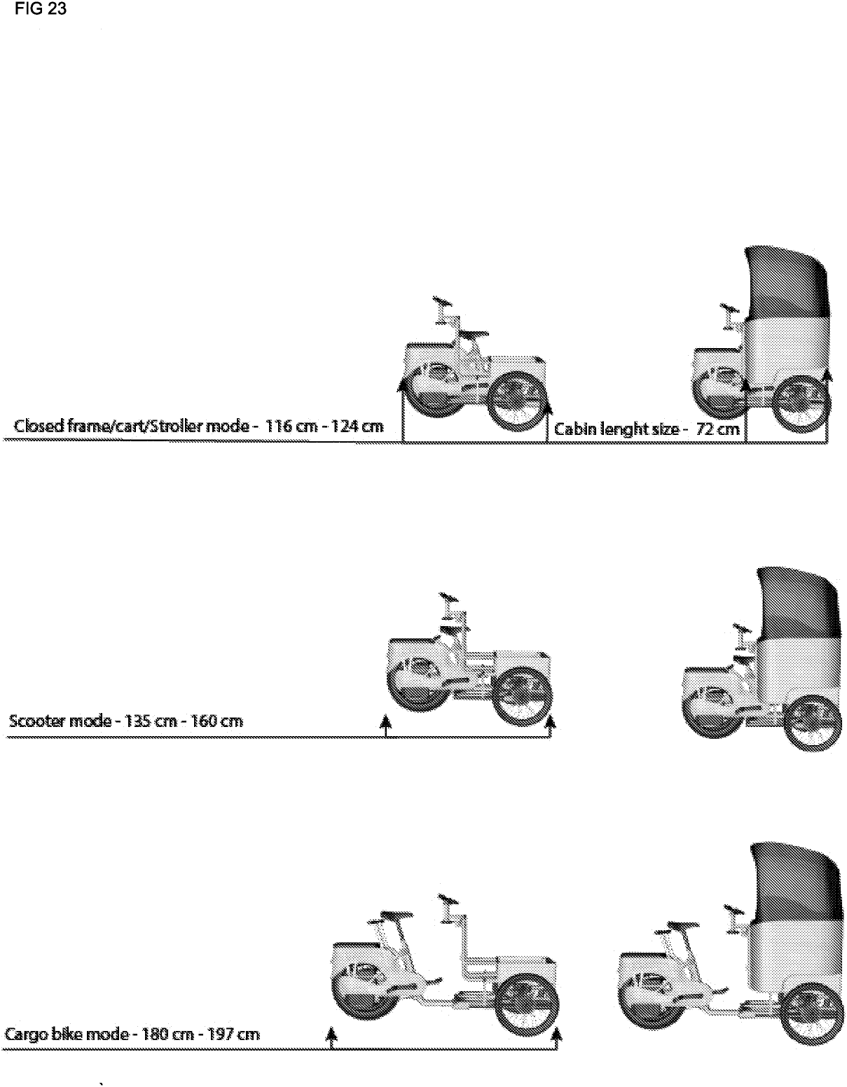

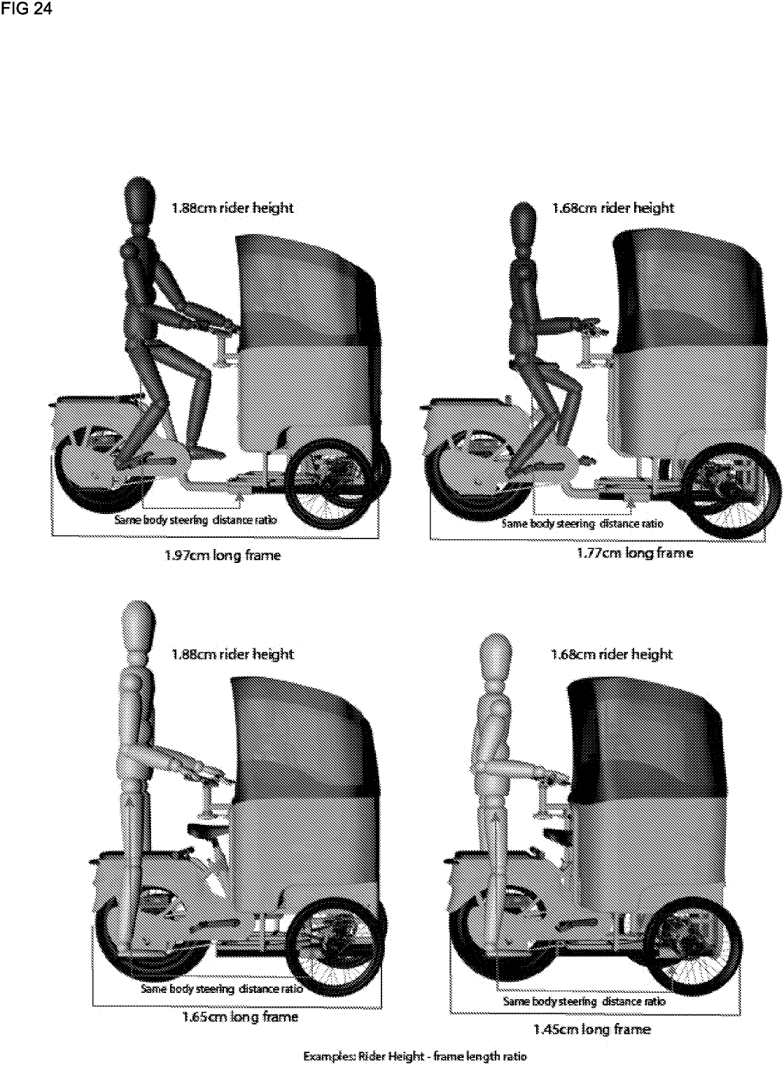

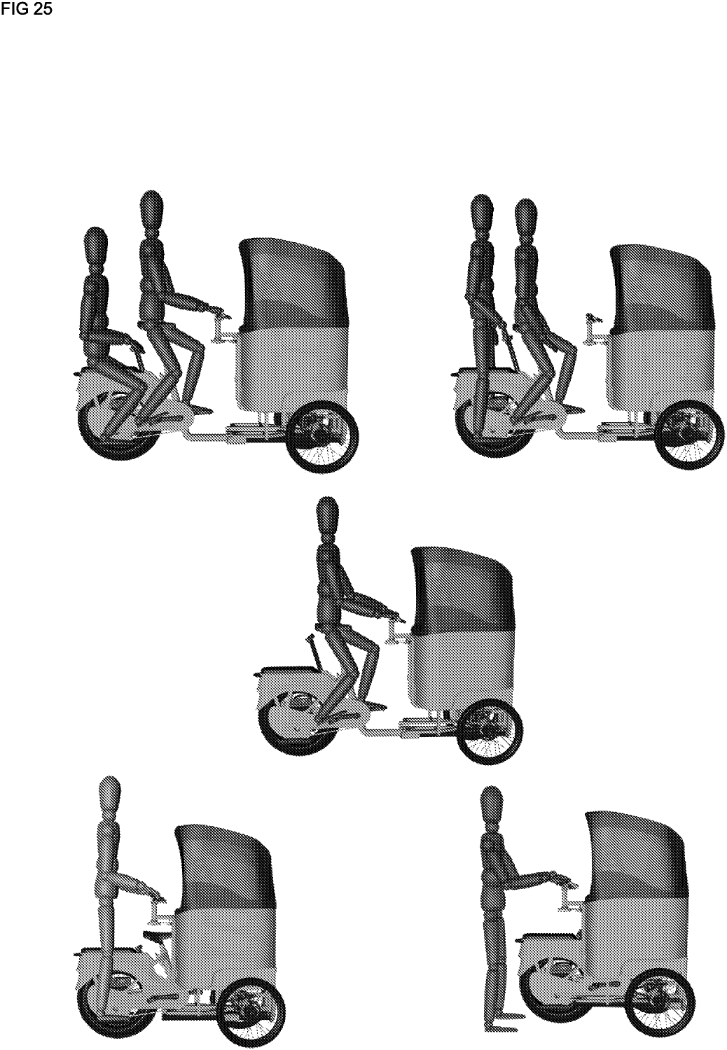

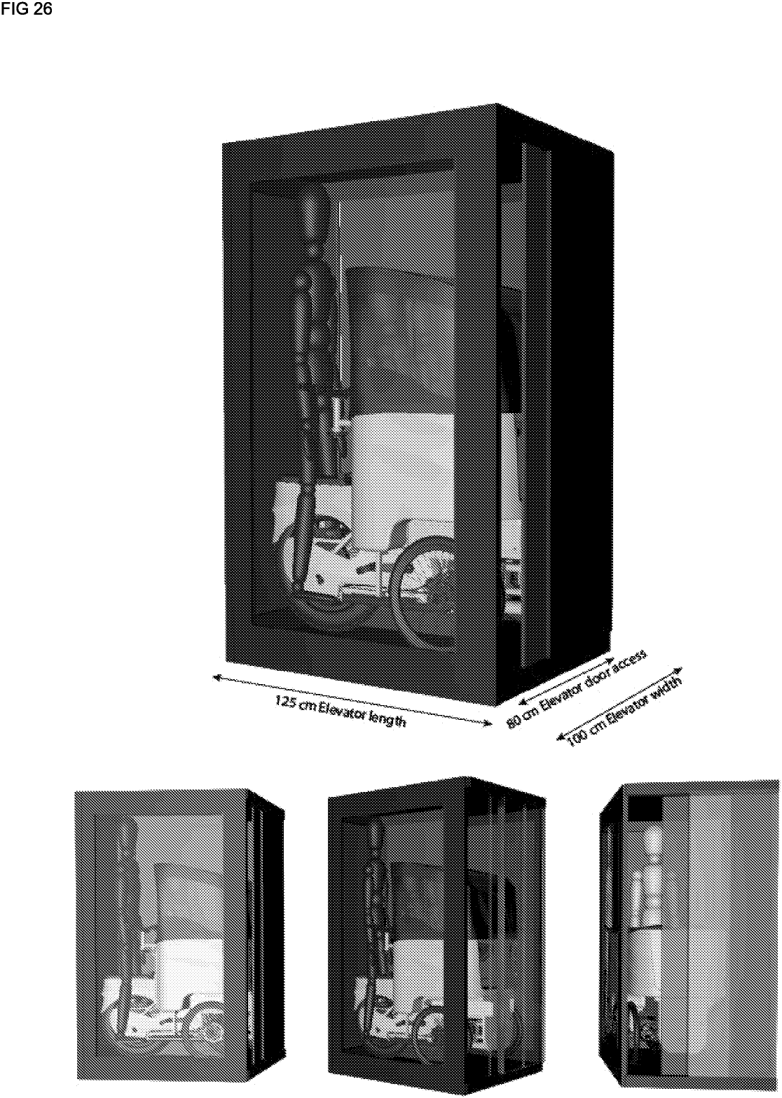

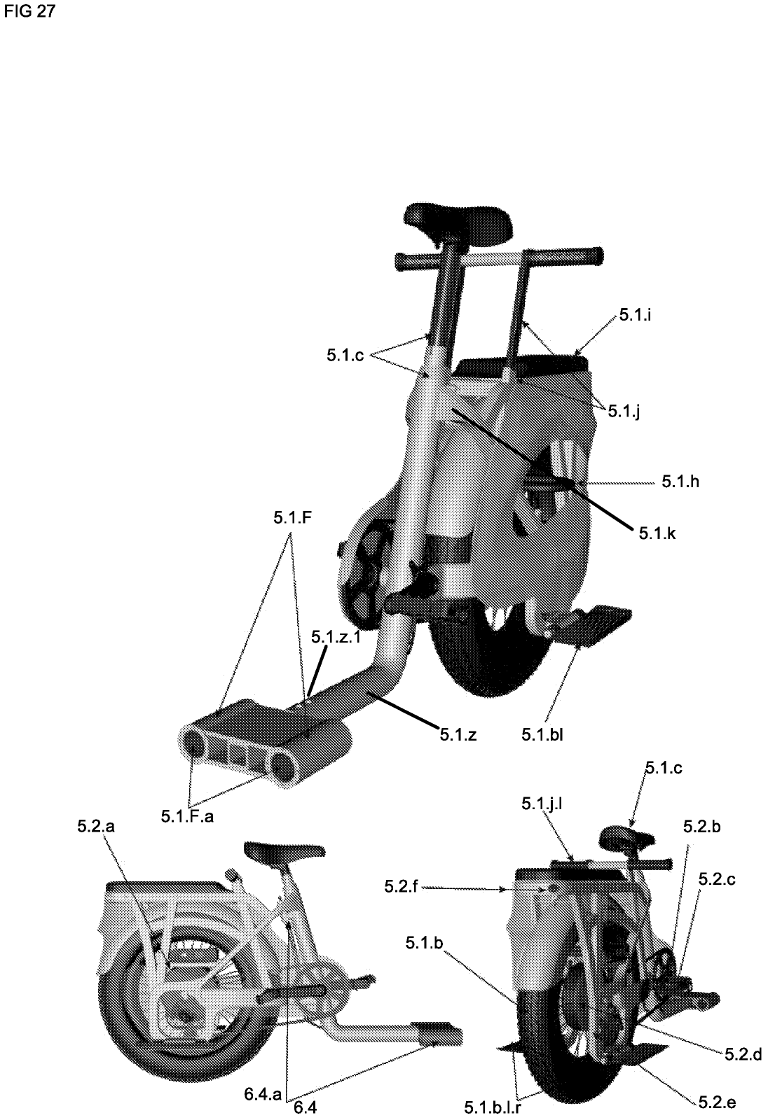

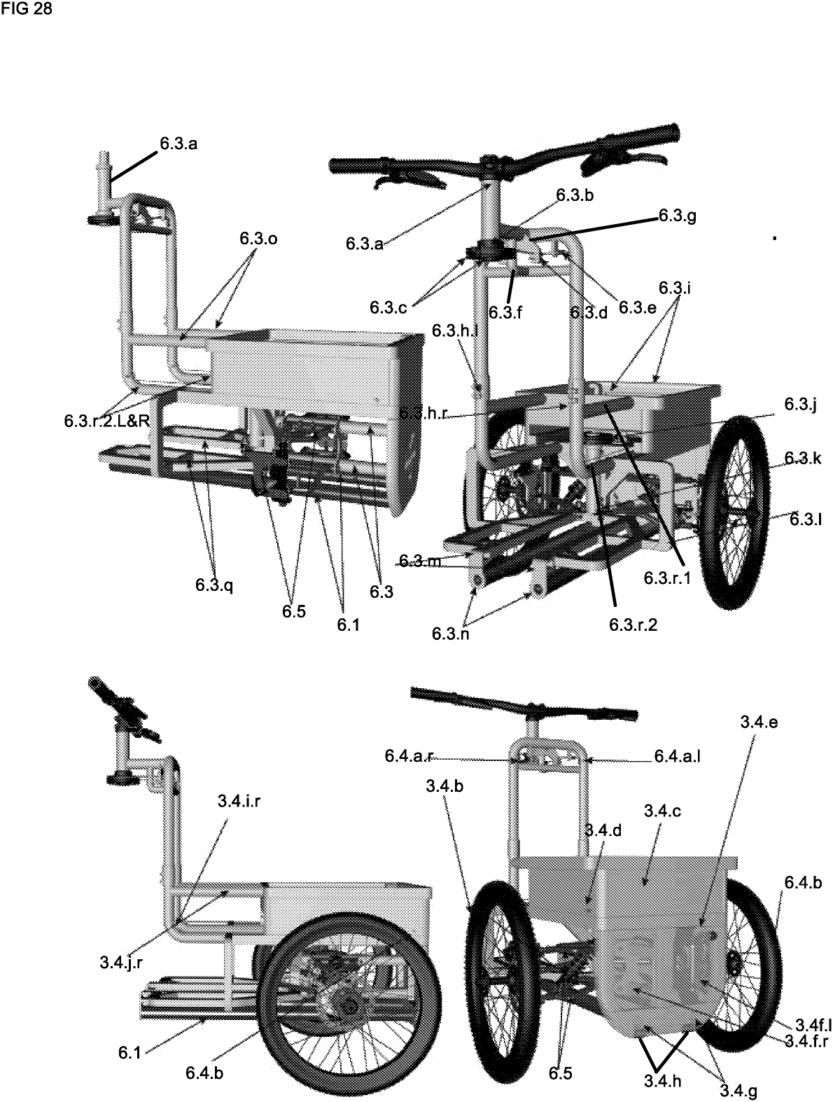

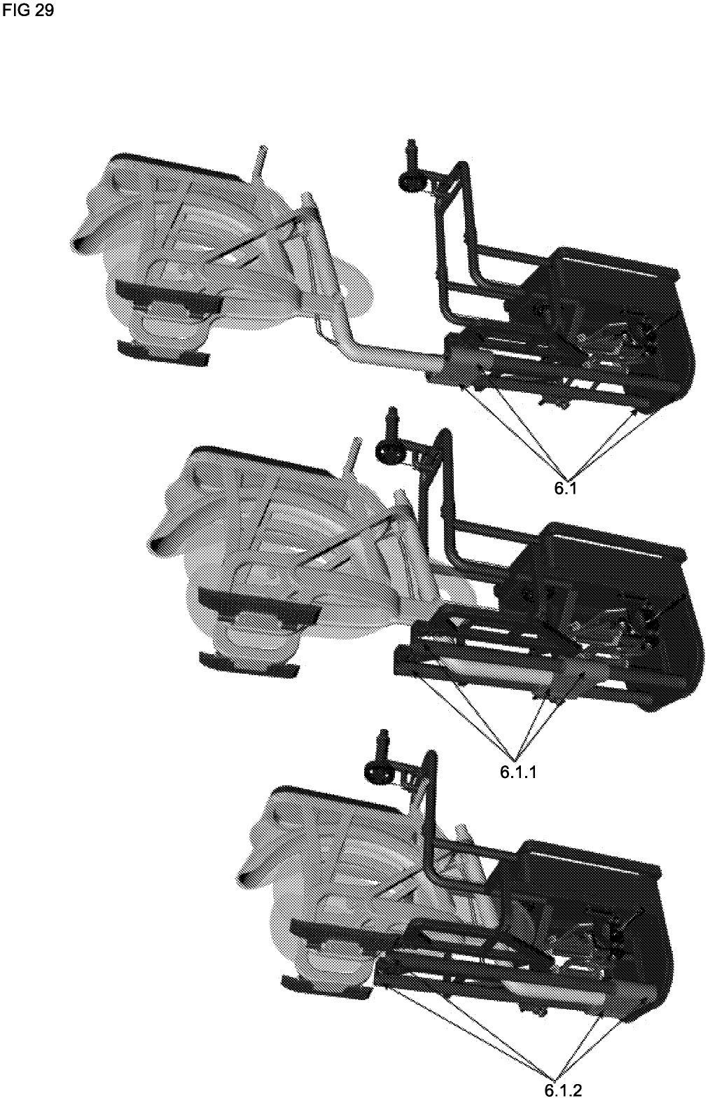

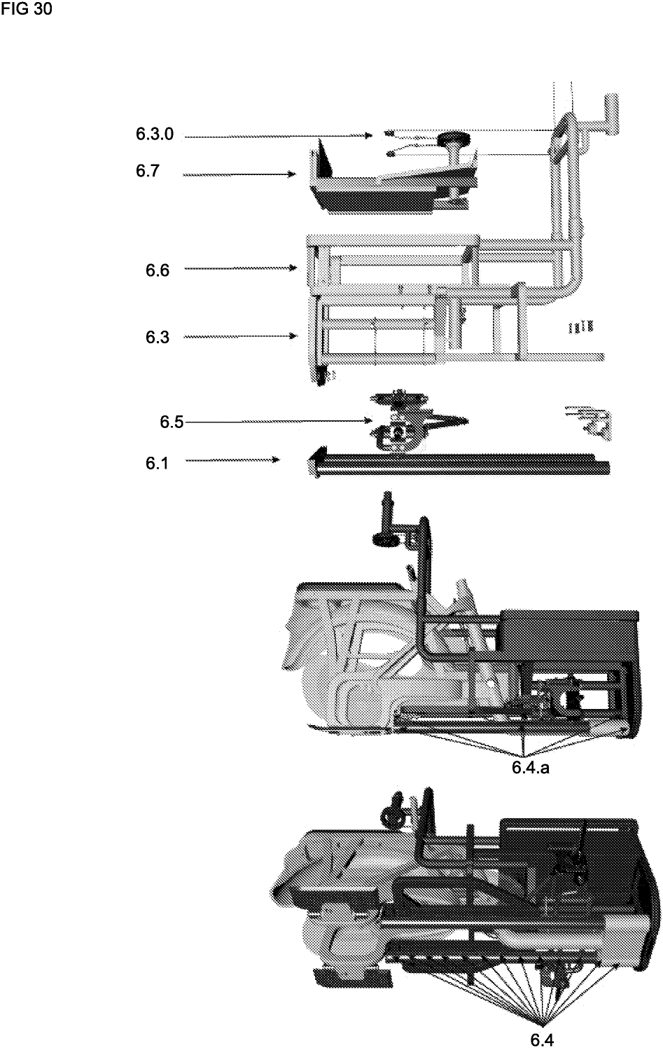

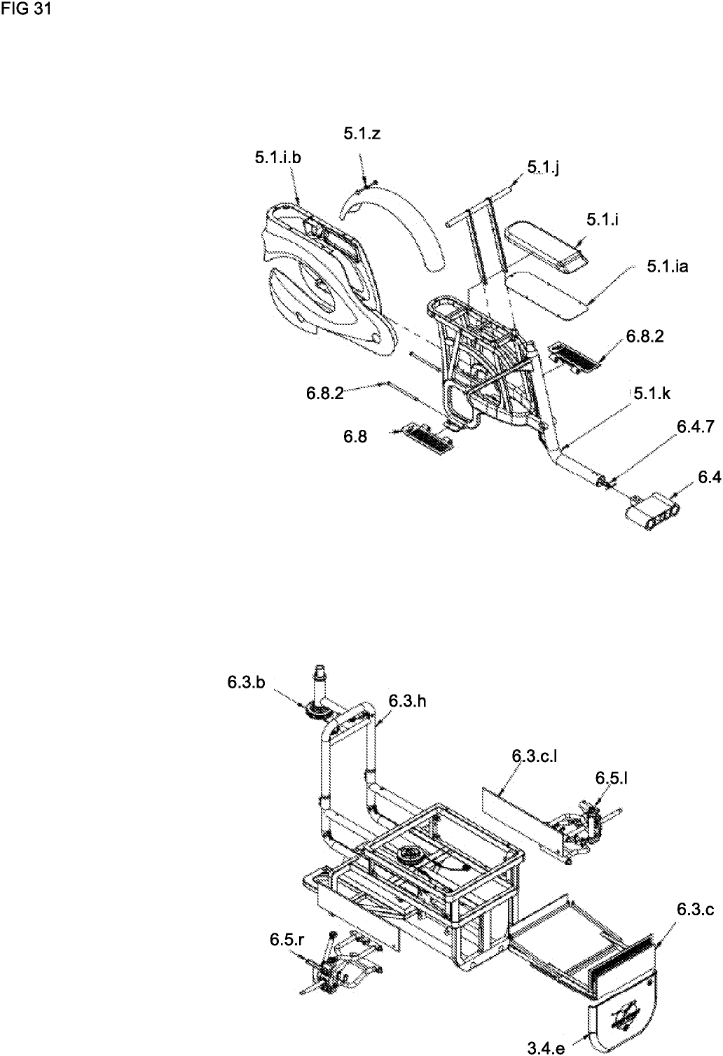

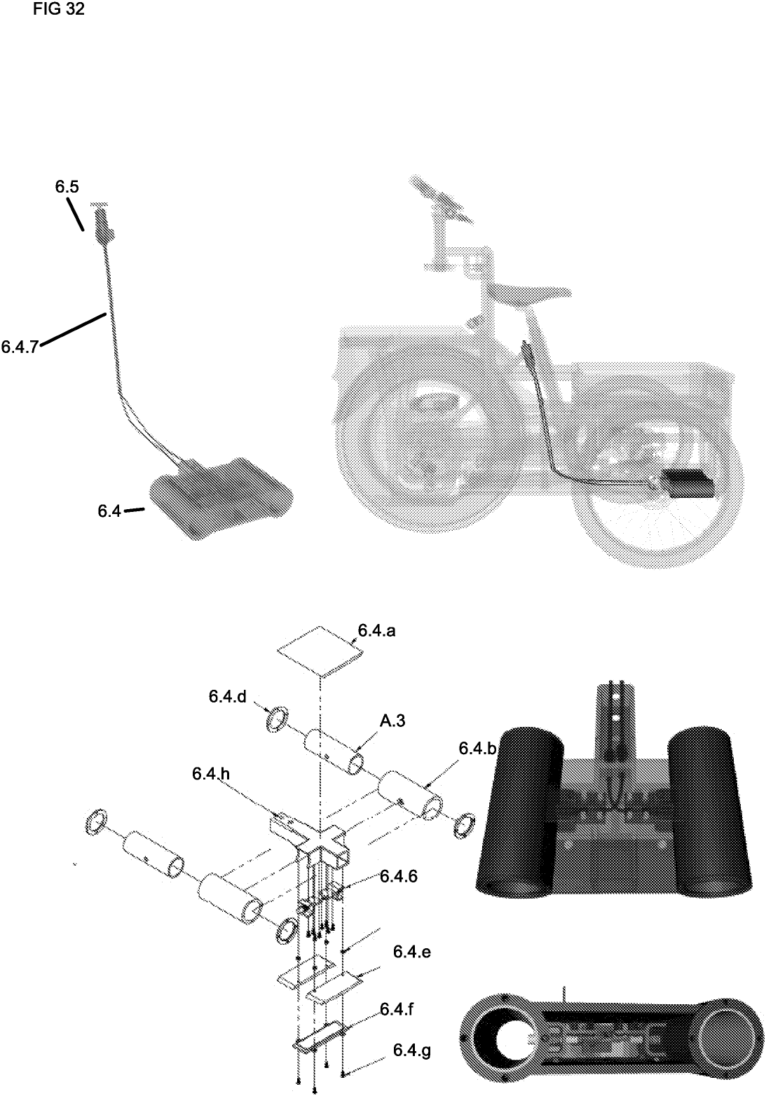

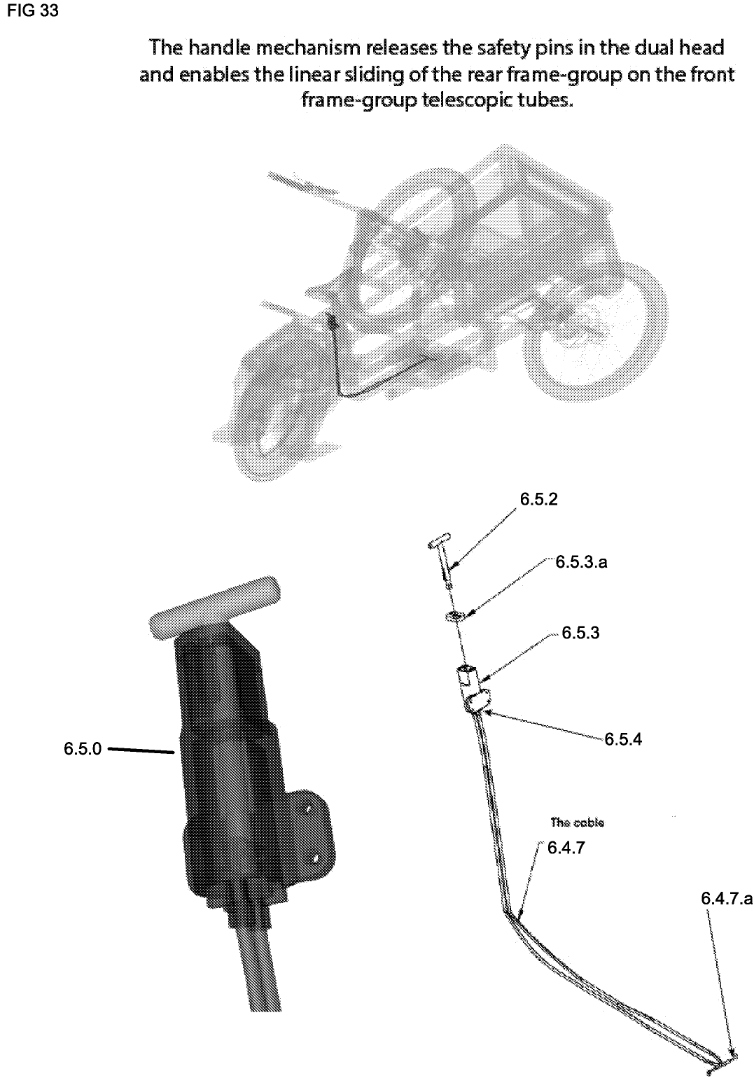

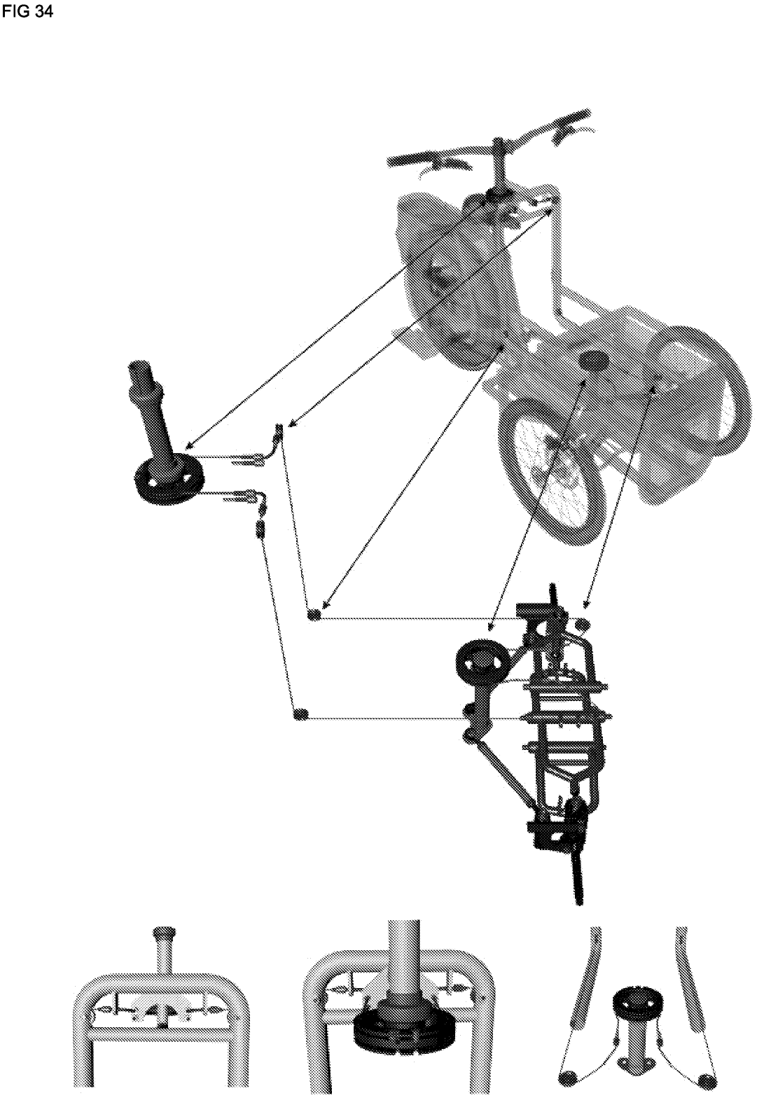

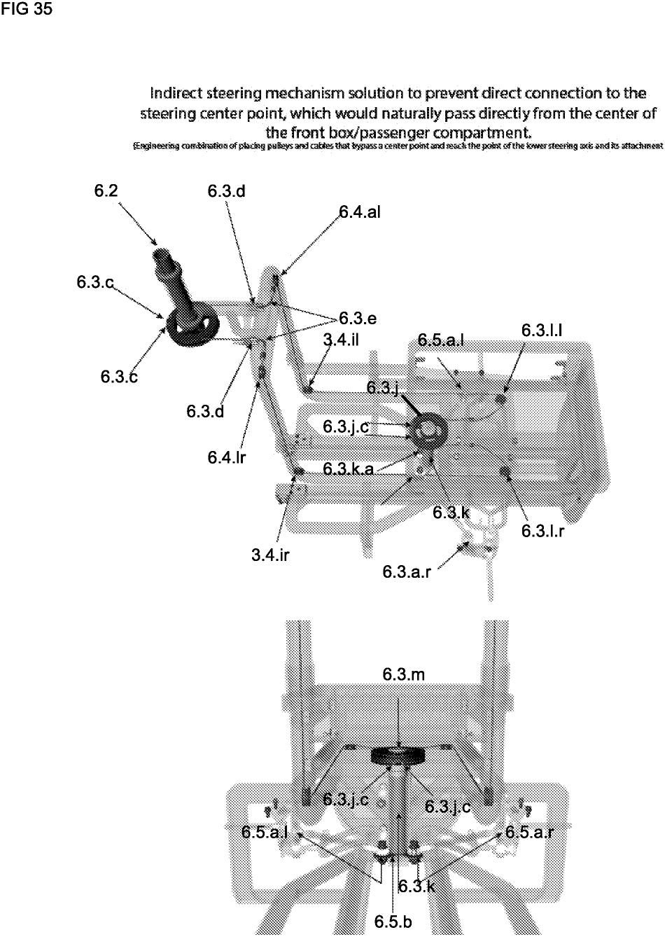

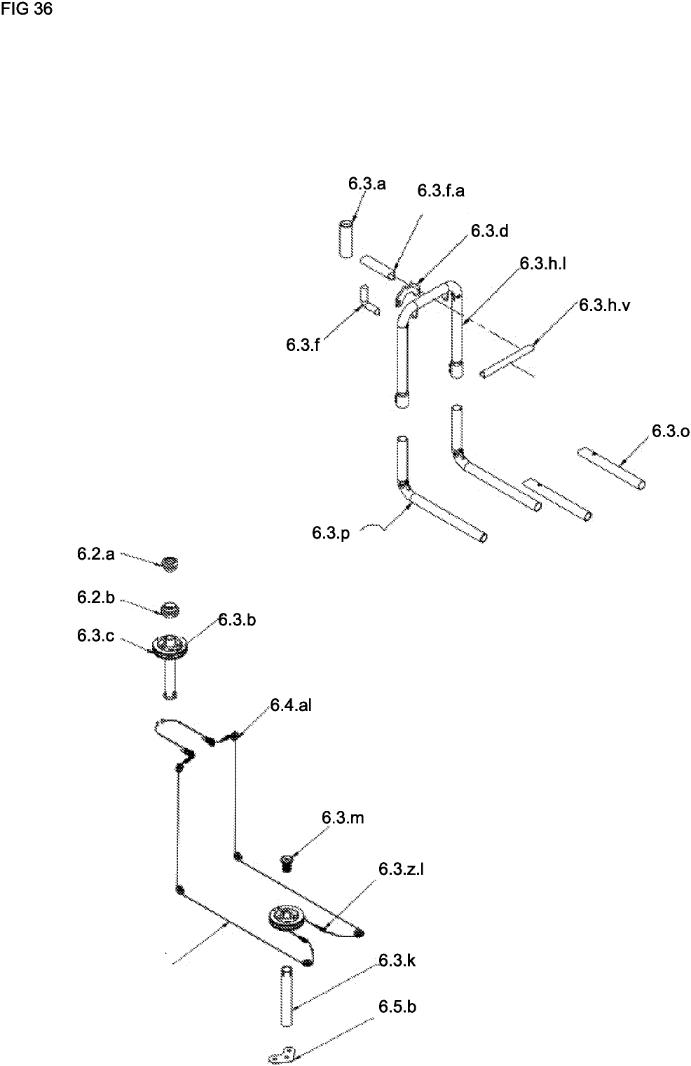

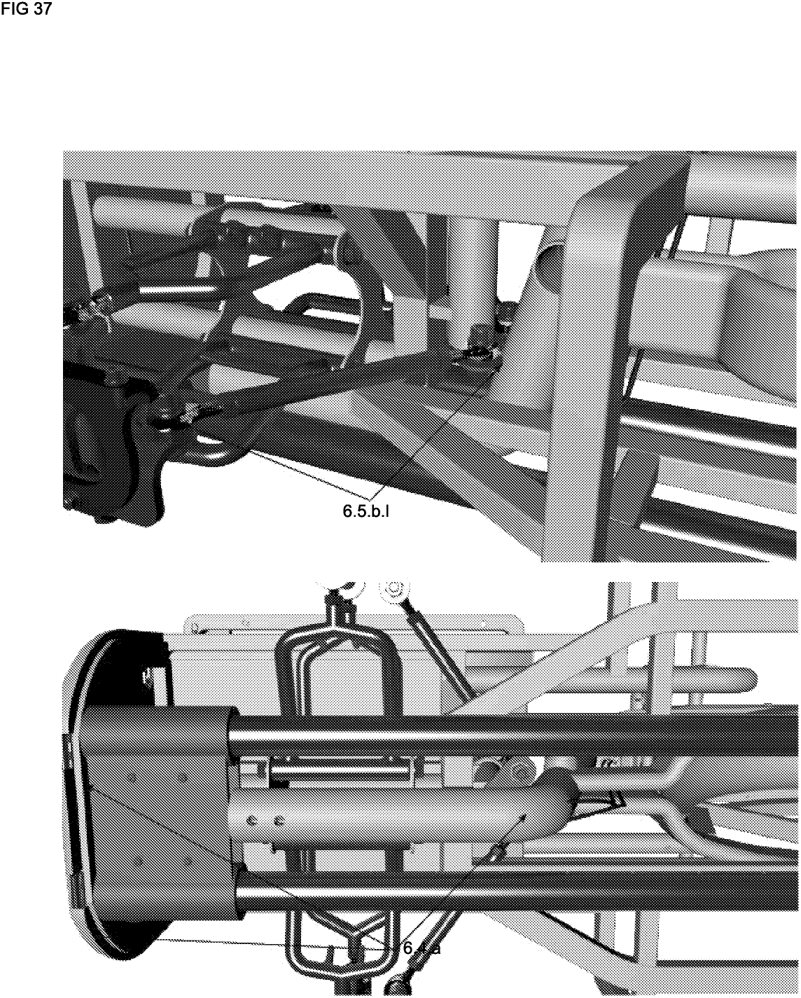

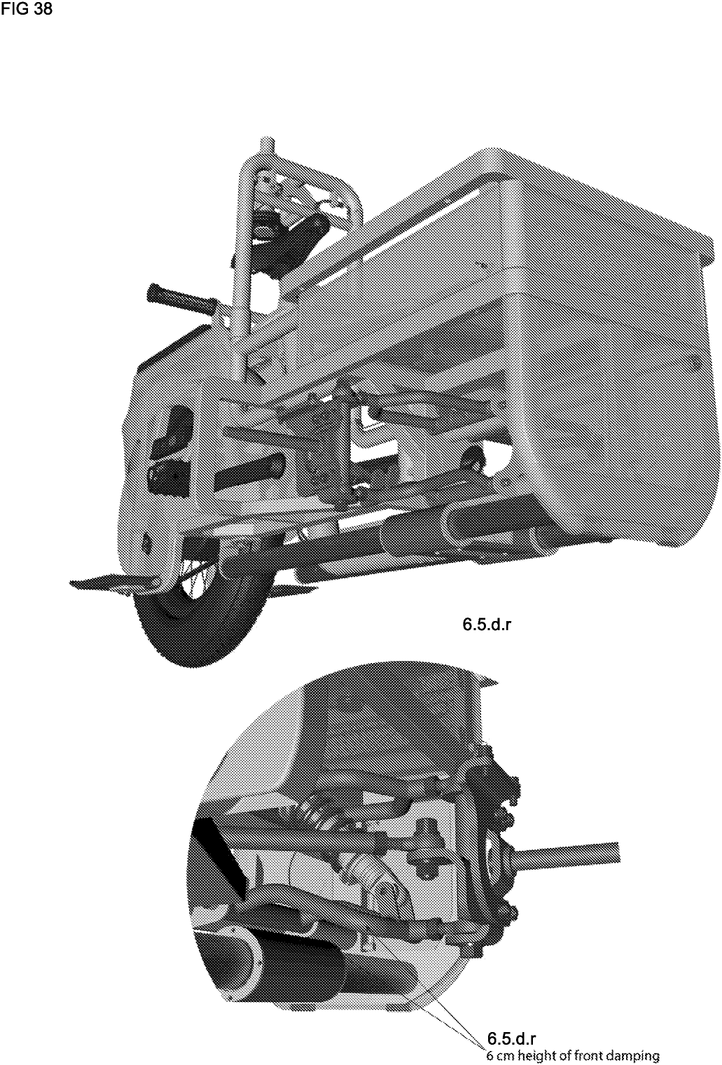

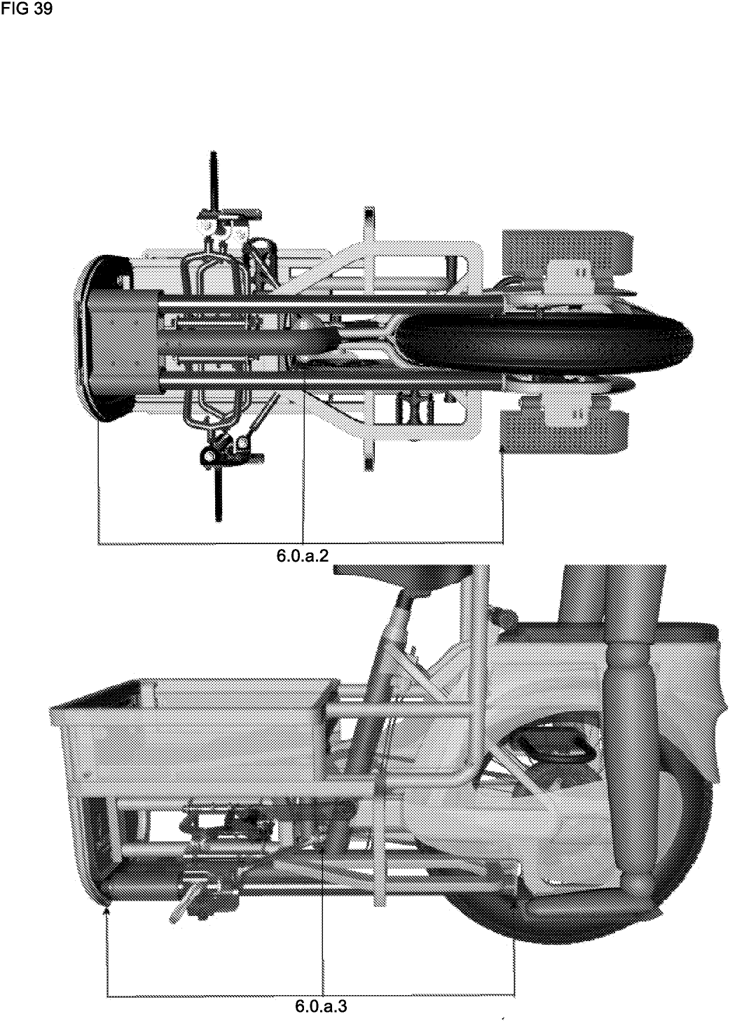

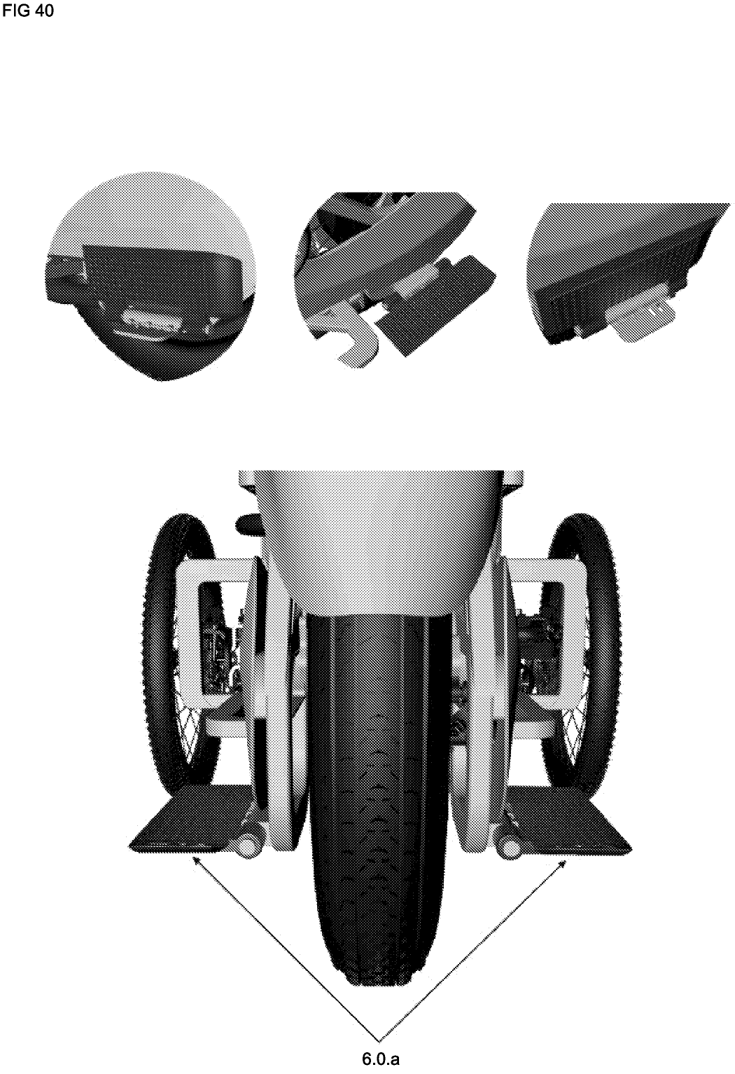

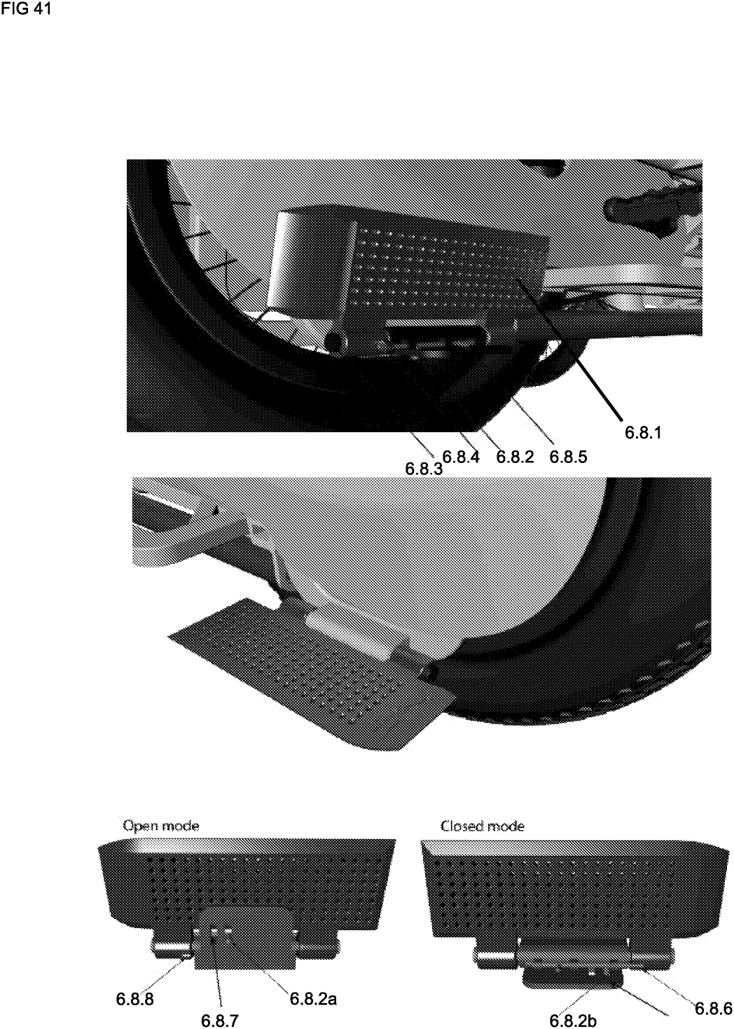

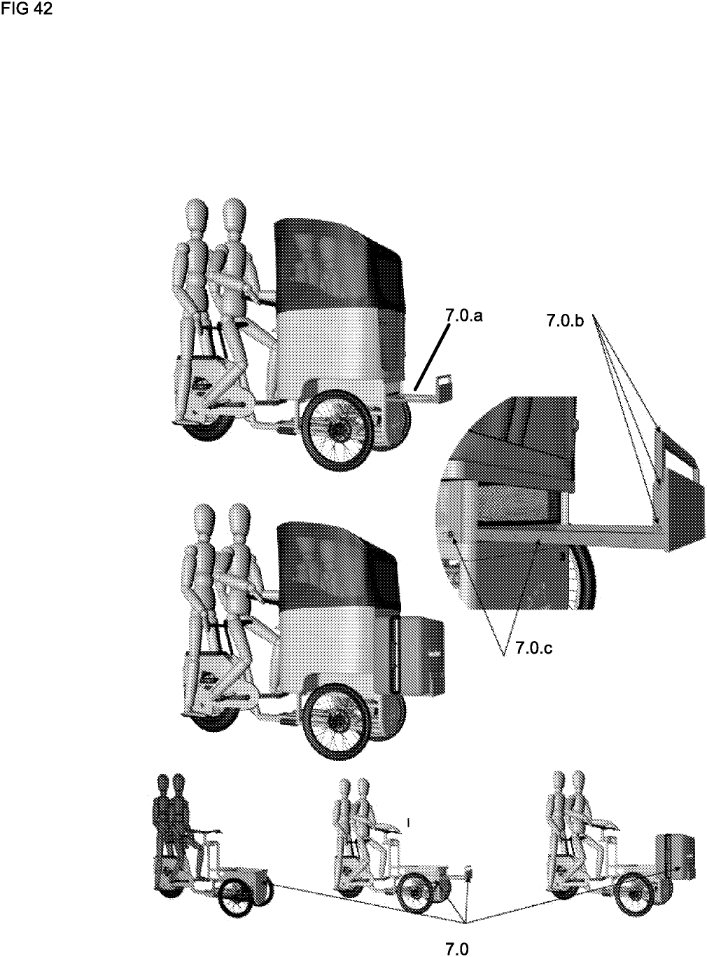

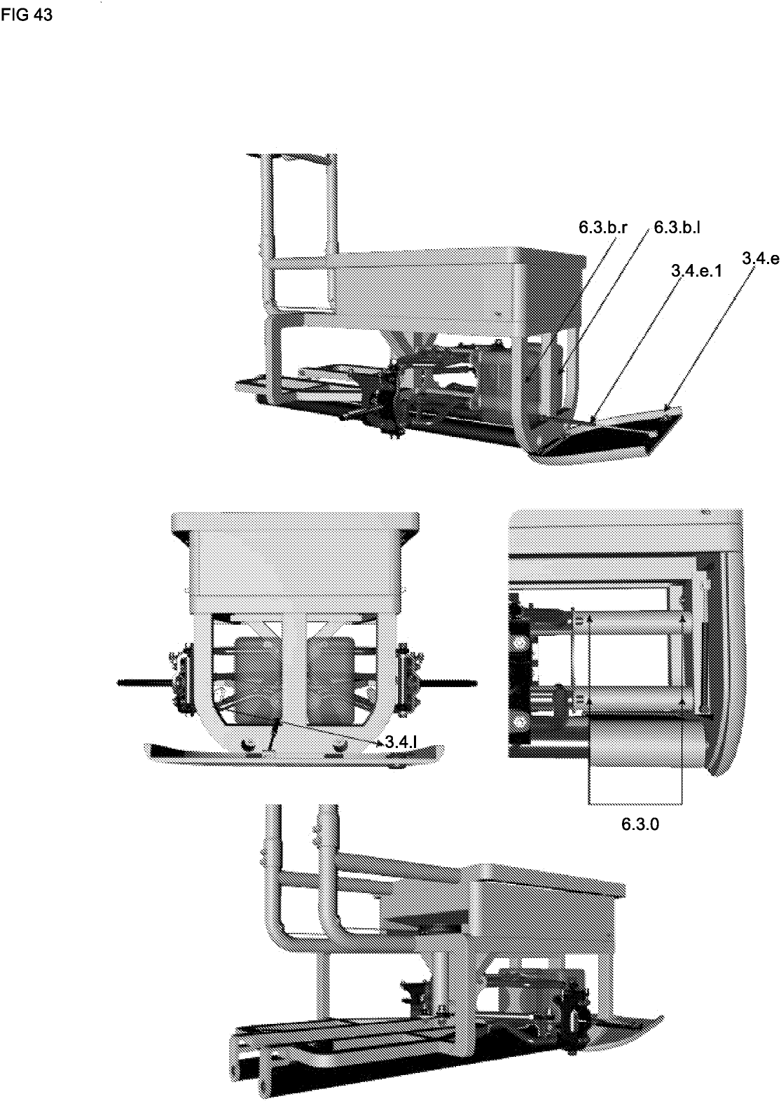

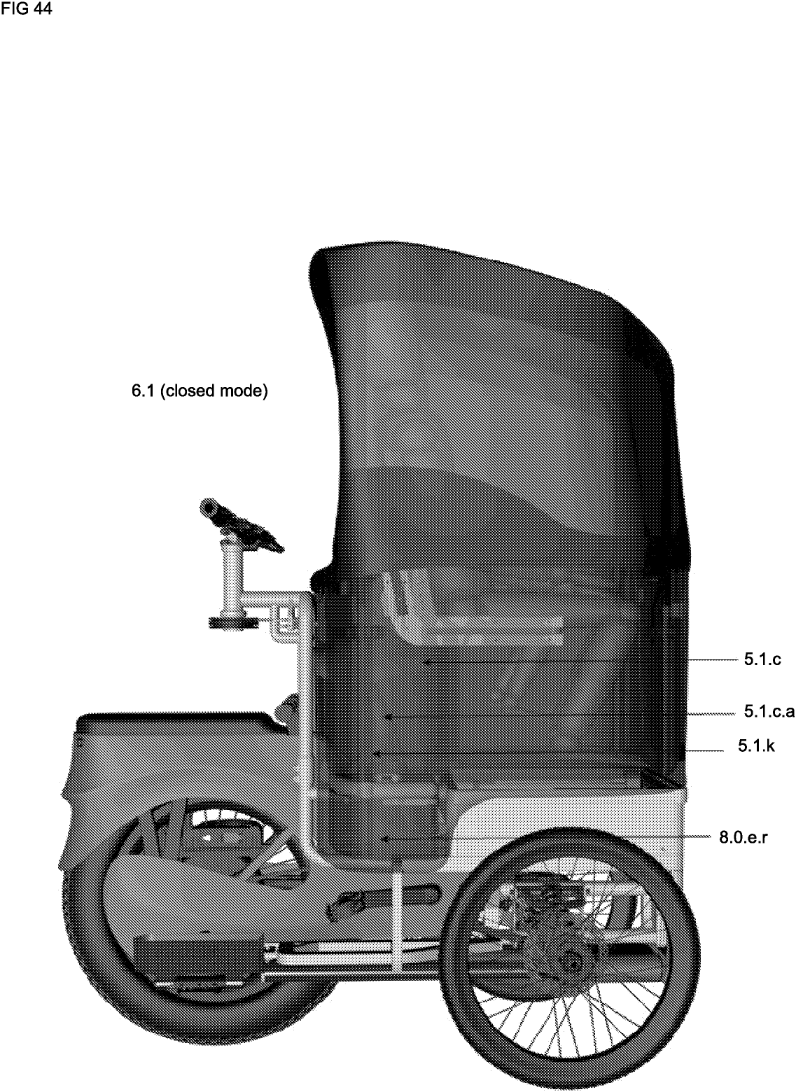

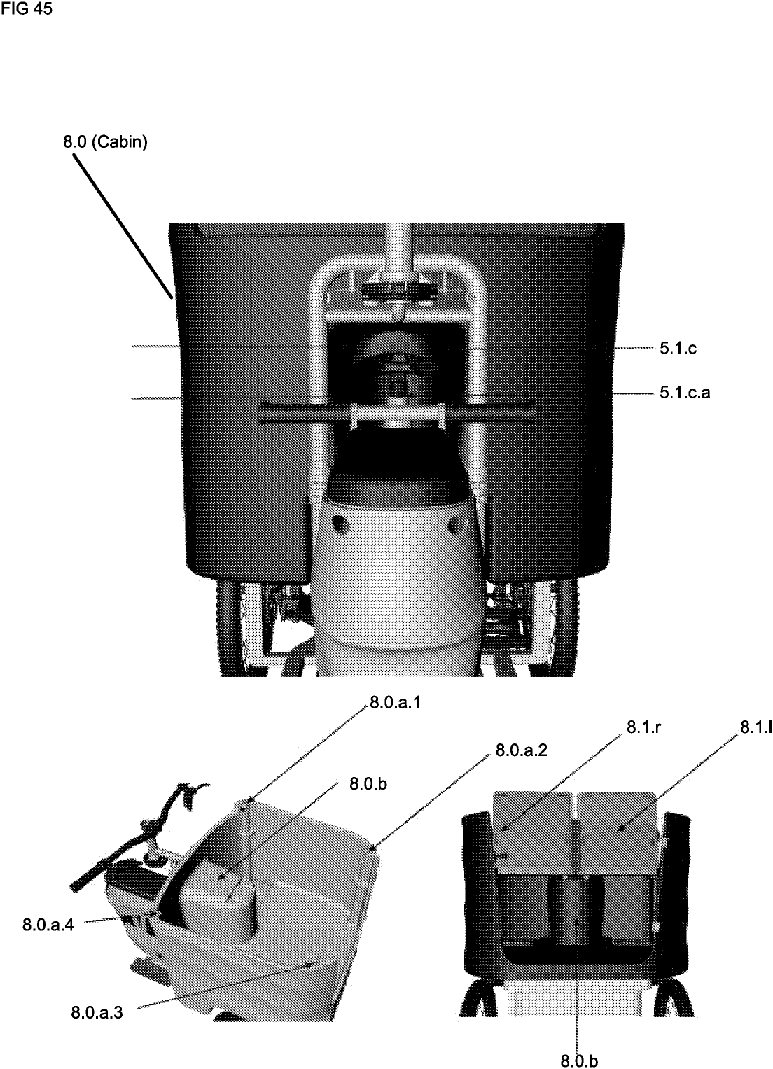

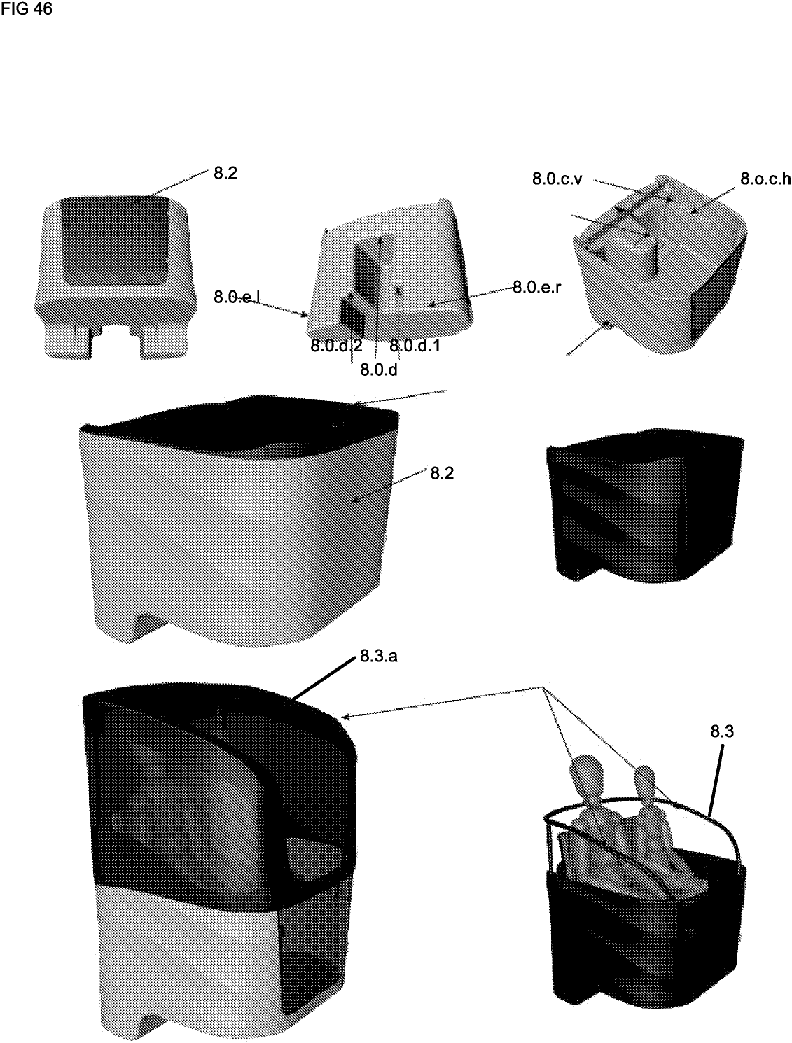

Referring to FIG. 18, the convenient scale of the cargo bike of the present disclosure is illustrated.

Due to the innovative space saving design of the frame, when in fully closed mode the bike can comfortably fit a rider and full cargo cabin inside a volume equal to the minimum legal volume for an elevator, solidifying the suitability of the frame for providing door to door cargo solutions.

The drawings show, to scale, (top left) the bike in stroller mode in such an elevator with the rider standing behind and pushing the bike with two children housed in the cargo cabin (top right) the bike in scooter mode in such an elevator with the rider standing on the back pedals of the bike and operating an electronic motor to drive it forward.

The bottom set of images show (top left) the bike in scooter mode with cargo and partially closed mode (top middle) the bike in scooter mode with cargo and fully closed (top right) the bike in stroller mode with cargo and fully closed (bottom left) the bike in bike mode with cargo and fully extended (bottom right) the bike in bike mode, fully extended with both cargo and a passenger.

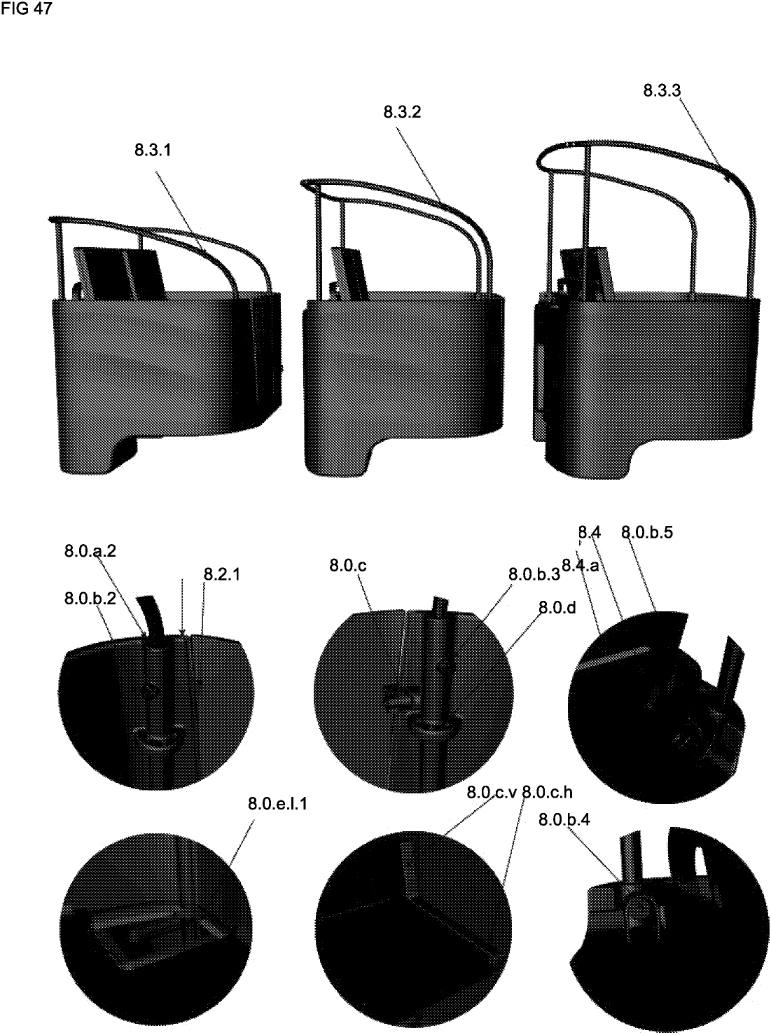

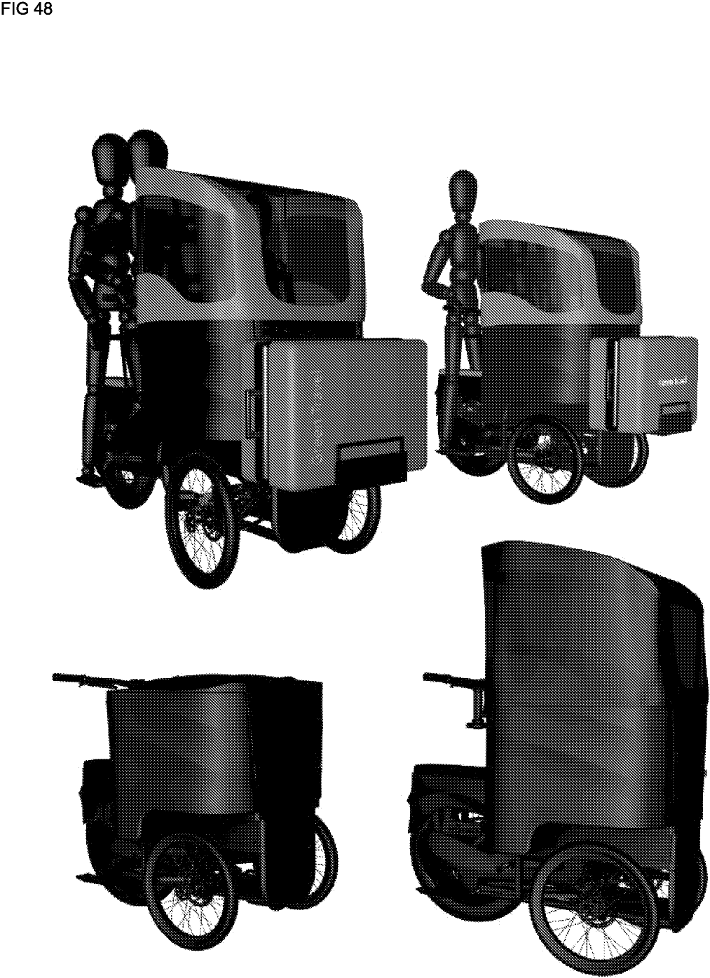

Referring to FIG. 19, multiple different possible configurations and designs of the cargo cabin are illustrated that could have various commercial door to door applications.

While the above-described embodiments provide excellent versatility and adaptability, other innovations can even further improve the capabilities of the disclosed cargo bike frame.

For example, the design of previously described embodiments can in some cases lead to problems or sub-optimal design choices. The steering solution, while beneficial, does protrude into the space which ideally would be occupied solely by the cargo cabin mounted on the frame/

Furthermore, the weight that a cargo cabin mounted on the previously described embodiment can hold is limited by the supporting frame element. The previously described U-structure that accommodates the underlying substructures can only withstand a certain amount of pressure.

Three major points of innovation that were designed to overcome these problems, as well as several beneficial technological developments are described below in a set of alternative or improved embodiments of the disclosed cargo bike.

It should be noted that each innovation can be implemented as a standalone improvement, but together the three improvements are highly synergistic, complimenting each other. Thus they are illustrated as all being incorporated in these improved example embodiments.

Thus, referring to FIG. 20, a general overview of the improved cargo bike in a cargo bike mode is shown in a fully open (extended) mode with (top) and without (bottom) a cargo cabin box installed. The modified structures are illustrated and described in more detail with reference to later figures.

As can be seen, the new structure comprises several changes. A first major improvement comprises a restructuring of the front bike frame part, with the U-shape of previous embodiments being replaced by a reinforced layered cage having an upper portion configured to support a much heavier cargo cabin and also a modified steering structure. The cage structure also comprises a lower portion configured to encompass the suspension and pedal system, as well as reinforcing the support for the upper part while still allowing the telescopic tube mechanism to slide underneath and within.

The upper part and lower part are connected by a plurality of reinforce bridges that are shaped to provide exponentially greater support without impacting on the space required for both the cargo cabin mounted atop and the portions of the rear frame of the cargo bike that slide forward into the central space underneath the steering handles.

The portions of the rear frame surrounding the rear wheel are also visibly reinforced.

The adapted steering mechanism has been changed such that the point of rotation is no longer biased away from the central shaft, but instead the central shaft is shortened and connected to a unique pulley assembly that separates the steering cable connected to the wheels out and around the central space of the frame and reconnects with a second central pulley within the reinforced cage structure that encompasses the suspension. This shall be described in more detail with reference to later FIGs.

Referring to FIG. 21, the same general overview of the improved cargo bike in a cargo scooter mode with the frame partially retracted, with and without the cargo cabin box mounted on the front part.

Referring to FIG. 22, the same general overview of the improved cargo bike in a cargo stroller mode with the frame fully retracted, with and without the cargo cabin box mounted on the front part.

Referring to FIG. 23, the cargo bike is shown in at various levels of closed/open, seamlessly converting form one mode to another. FIG. 23 is meant to demonstrate the differences in dimensions of the bike that can be achieved easily and without disassembly. Example dimensions are given for each mode.

Referring to FIG. 24, riders of various heights are shown riding the cargo bike of the present disclosure which has, for each different height and arm length of the rider, been adjusted to the perfect ergonomic size to match their physique.

Referring to FIG. 25, the various modes the bike can be ridden in and which can accommodate passengers are shown again. As can be seen the improved variant of the bike provides extra comfort for passengers to the rear of the rider by providing a retractable handle for them to grip and a second set of stride pedals. The rear frame alone can accommodate up to 180kg of weight.

Referring to FIG. 26, the bike and rider are shown again to scale in a minimum size elevator form various angles. As can be seen they fit comfortably inside, thus allowing riders to enter elevators with the cargo bikes in both private and commercial settings including shopping malls, metros, trains, supermarkets and coffee shops without removing the mounted cargo cabin or even having to take their feet off the pedals.

With reference to FIGS. 27 to 44, the various innovative features of the improved cargo bike frame design will now be explained in more detail.

Referring to FIG. 27, the rear module comprises a telescopic tube 5.1.cthat connects the frame to the seat and allows for adjustable height, a rear seat/cushion 5.1.i for a passenger to rest their weight behind the rider.

A retractable telescopic handle 5.1.j for the passenger to stabilize themselves with is also shown, the handle retracts downwards along with the rider seat when the rear module is pushed forward into the front module, allowing the front module frame to overlap all the way past and over the handle 5.1.j. The retractable passenger handle has grips 5.1.j.l on either side.

Stride plates such as left stride plate 5.1.b.l are disposed either side of the reinforced rear frame. The stride pedal is connected to the frame by a foundation 5.2.e and is shown in open mode 5.1.b.l.r 2 .

Furthermore, an integrated bike lock 5.1.h for locking the rear wheel may be included in some examples. Element 5.1.k is a seat stay reinforces the support for the rider seat. The bike lock comprises a U shape lock bar shown in a docking position 5.2f and which is attached to a foundation 5.2a of the frame.

Referring to 5.1.f, the dual tube head mechanism is shown. The mechanism is for the most part as described in relation to the first embodiments, but in the improved variant disclosed here the pin lock mechanism is disposed entirely within the housing and the pin locks both side of the telescopic tube mechanism (see FIGS. 32-33).

The inner sides of the female tube head of the dual head mechanism comprise a Nylon 6 inner coatings/tubes 5.1.f.a. The dual head is connected to the main rear module central frame by tube 5.1.z. Furthermore, the dual head mechanism position along this tube can be changed by detaching it and remounting it at the various locking points 5.1.z.

The drive mechanism comprises a standard crank chain set 5.2.b, with a crank arm 5.2.c for the pedals. The drive mechanism also comprises a rear hub engine 5.2.d.

The rear wheel 5.1.b is in the present example a fat tire wheel, but any type of wheels with width up to 26 cm can be accommodated.

Element 6.4 refers to the dual head lock mechanism as a whole, with 6.4A showing the handle/trigger used to operate the double sided pin lock mechanism within the dual head, the cables run through the shaft of 6.4a and connect to either side of the telescopic tube assembly. The telescopic tubes of the improved version each have holes all along their length for maximum length adjustments and compatibility with the new double-sided locking mechanism.

Referring to FIG. 28, the front module of the improved embodiments is shown, including the new reinforced cage structure and adapted steering configuration.

As explained above, the steering mechanism comprises a shortened steering shaft 6.3a which connects to an upper portion of the reinforced cage, branching out into a U shape.

The end of 6.3a is a first central pulley 6.3b, which has disposed about it a steering cable 6.3c that is threaded through a pulley assembly that is integrated with the cage structure.

The threading is partially controlled by an adjustable rear noodle cable break screw foundation 6.3d which provides the correct tension for the threaded steering cable to effectively control the steering of the bike, the tension can be easily adjusted by screwing 6.3d one way or another. There is a corresponding front noodle cable break screw foundation 6.3e.

The cable is split and directed into the tubes forming the U-shape by small left and right pulleys 6.4.a.l and 6.4.r that cause an angle break of the cable by 90 degrees before threading it through the tubes to the lower pulley assemblies. The bend of the tubes each comprises second smaller pulleys 3.4.i.r for the left and right sides of the cablet that break the direction by another 90 degree angle, threading it through to the main body of the cage structure.

The upper frame part of the cage connects to the steering assembly and comprises a plurality of supports such as element 6.3.f and 6.3.g which provides a foundation for the noodle pipe assembly of the four cables.

The U-shape of the reinforced cage upper portion is adjustable in height by the left 6.3.h.l and right 6.3.h.r foundation points that join the steering assembly to the cage structure foundation tubes.

The reinforced cage structure also comprises various support tubes connecting the U-shaped portion to the cabin mounting portion such as support tubes 6.3.r.1 and to the lower portion of the cage structure such as 6.3.r.2 and 6.3.r.2.L&R. These tubes in turn are connected to the amin body of the cage by supports 6.3.o. These tubes also house the left and right pulley assemblies that direct the pulley cable back to a central point within the center of the reinforced cage.

The second central pulley of the steering assembly 6.3.j is visible within the cage, this is the pulley that is connected to a central steering shaft 6.3k that in turn is connected to the actual suspension and wheel os the vehicle as will be explained below.

The upper and lower layers of the reinforced cage structure are in the present example connected by sturdy frame supports such as 6.3.l, which is designed to be quite wide so as to providing structural integrity without interfering with the space for the pedals of the rear frame module in closed mode.

A forked support element 6.3.m, with two master screws 6.3.n that allow for easy disassembly, and reinforcements 6.3.q, connects the lower portion of the cage structure to the telescopic tube mechanism, preventing weight form cargo and rider from overly burdening the telescopic connection and interfering with it.

The upper front frame foundation 6.3.i is configured to receive accompanying cargo cabin boxes and is placed at a height that prevents interference with the lower assemblies, as well as providing a height distance from the front wheels for a damping ratio of minimum of 6 cm.

The surface 3.4.c is actually a cover for retracted front telescopic rack for suitcases as will be explained below. 3.4.d is an access door for the internal parts of the front module and can house a set of front batteries, which can be accessed respectively form positions 3.4.f.l and 3.4.f.r. Access to the master screws that connect the front side of the telescopic tubes can be gained from position 3.4.g if needed.

FIG. 29 clearly illustrates how the various structures interlock as the rear module slides forward into and underneath the front module. Since the cage structure keeps the central area underneath the steering handles free to receive the centrally located seating assembly of the rear module. The sliding is facilitated seamlessly by the telescopic tube assembly 6.1

Referring to FIG. 30, an exploded view of the various layers of the front module assembly of the improved version of the cargo bike is shown, with the pulley assembly 6.3.0 shown being threaded through the U-shaped upper portion form above and then connected to the lower central steering shaft which is in turn threaded down through the cage structure to connect with the suspension 6.5

The retractable tray mechanism 6.7 is shown here in more detail, and would normally rest within the cabin mounting portion 6.6. The lower portion to eh cage structure 6.3 has various supports to prevent the weight of the cabin from compressing it down and causing interference with the more delicate suspension mechanisms etc. The telescopic tubing mechanism of the front module 6.1 has the same stopping bar at the end to prevent collision of the two parts by overextension.

Below the exploded view there is shown two illustrations of the rear module interlocking in a fully closed mode with the front module.

As can be seen, the design and various improvements are highly synergistic and allow for perfect interlocking of the two modules.

Referring to FIG. 31, a schematic design is shown of the various components of the improved embodiment.

The top illustration shows an exploded view of the components of the improved rear module.

The rear modules reinforced housing 5.1.i.b encompasses the rear wheel and provides protection for the internal mechanisms. This is further supported by a mud cover 5.1.z that is placed over the rear wheel but heavily curved to avoid extending the overall length of the bike.

A connector 6.4.7 that is part of the dual head locking mechanism is shown protruding from lower central tube 5.1.k, threading it through to the dual head assembly, which as mentioned before comprises pin locking mechanisms for both tubes in the improved variant.

The lower illustration shows an exploded view of the front module components and better illustrates the route that the pulley assembly takes the steering cable through. As can be seen the first central pulley 6.3.b splits the cable out to the left and right sides of the U-shaped frame 6.3.h, threading it into the tubing of the frame through the noodle cable breaks. Smaller pulleys route the cables through the tubing euther side using 90 degree breaks and then reconnect it with the second, lower central pulley which is attached to the lower central steering shaft. The pulley system allow the axis of rotation of the central steering shaft to remain behind the cargo cabin space, such that the cabin does not need to be wrapped around it.

The suspension groups 6.5.r and 6.5.l etc are protected at the sides by covers like 6.3.c.l. The retractable suitcase rack 6.3.c slots into the upper portion of the cage structure and as mentioned above a lower door/cover 3.4.e provides access to internal components located at the front - it is often convenient to locate batteries for the drive mechanism here due to the weight implications.

Referring to FIG. 32, the locking mechanism of the dual head and the connection to the trigger for controlling it in the improved embodiment are illustrated in more detail.

The main reason for the modification to the locking mechanism are that the improved version of the cargo bike are capable of handling heavier loads, and that with heavier loads on the cargo bike, small imbalances that might be cause by a one-sided locking mechanism can actually have a greater impact on the functioning of the bike. It is thus beneficial to implement a double sided lock that applies the pins to both telescopic tubes.

The top left image shows how the trigger 6.5 is connected to the dual head 6.4 by two separate braking cables 6.4.7. The trigger in the present example is in the form of a pull-to-release handle that is directly connected to the two cables, which in turn are each connected to a corresponding locking pin disposed within the dual head 6.4.

Each of the trigger 6.5 and the separate locking pins within the dual head 6.4 comprise a spring mechanism for biasing them towards a locked position. As explained above in relation to the first embodiment, pulling the pin allows the male telescopic tubes to slide through the female openings, i.e. the nylon6 inner tubes of the dual head, until the trigger is released and the locking pins are inserted into the same or a different hole along the length of the telescopic tubes. In this manner the length of the cargo bike is easily controlled through the operation of an ergonomically placed trigger 6.5

The top left image shows the same locking assembly disposed within a semi-transparent illustration of the cargo bike in a closed position to illustrate its relative position on the cargo bike.

The lower images illustrate in greater detail the internal components of the modified dual head 6.4 and the dual pin locking mechanism within.

As mentioned, the improved dual head houses the pin-locking mechanism completely internally, and thus needs to be covered by an upper support plate 6.4.a and lower support plates 6.4.e, as well as a removable cover 6.4.f that can be taken away to gain access to the internal portions of the dual head.

The female telescopic tube components are shown either side, including the inner nylon6 tubes A.3, the cover tube 6.4.b, and front and rear break rings 6.4.d for each tube which keep the nylon6 inner tubes housed within.

The double sided locking pin assembly 6.4.6 rests within the cross shaped support tube 6.4.h, directing the cables 6.4.7 that are threaded through the it to the tubes either side.

Referring to FIG. 33, a second skeletal view of the locking mechanism disposed within the cargo bike in an open position is shown, as well as schematic and exploded views of the trigger mechanism 6.5.

The trigger mechanism is merely an example, but comprises a pulling handle 6.5.2, a piston assembly 6.5.3, a piston assembly housing 6.5.3.a and a dual-cable connector 6.5.4 for ensuring that the piston pulls both cables and thus withdraws both locking pins form their respective holes simultaneously. The ends of the cables 6.4.7.a cross over each other to attach to the corresponding locking pin.

Referring to FIG. 34, the pulley system of the improved embodiment is shown both isolated form and integrated with the cargo bike frame to better illustrate its structure within.

As stated above, this unique pulley system is used to avoid interfering with the central space below the steering handles of the cargo bike, which is needed both to maximize cabin space and to allow smooth interlocking of the central portions of the rear module with the cavity formed by the cage structure of the front module.

The pulley system is thus integrated with the frame and adapted so as not to impact on either the cargo cabin space or the ability of the rider seat to fully side forward, it comprises four separate turning points to achieve this enabled by small pulleys that thread it through either side of the cargo frame tubing. Conveniently it is also modular and can thus also be disassembled if needed.

Rather than having the steering handles connected to a long central steering shaft that is offset from the axis of rotation of the steering shaft as seen with the previous embodiment, the steering handles connect to the central steering shaft at the axis of rotation of the shaft, but the actual central steering shaft is shortened and connects to left and right steering shaft parts that form a U-shape which can accommodate the rider’s seat in closed mode.

At the bottom of the shortened central steering shaft a first central pulley that receives a steering cable which also splits out into left and right components that are connected to the left and right steering shaft parts respectively. An assembly of smaller pulleys then loop the left and right steering cable components back, through a series of 90 degree and 270 degree turns around the reinforced frame structure in a manner that does not impact on the cargo cabin space, eventually connecting the cables back to a second central pulley which is connected to a second central shaft.

This second central shaft is effectively the second part of the central steering shaft, and is connected to the arms of the wheel axles and suspension system via a butterfly such that when the steering handles are turned, the shortened central steering shaft is turned, causing the steering cable wrapped around the pulley system to move, turning both central pulleys in the same direction, causing the second central steering shaft to move the axles and steer the cargo bike as if it were connected directly to the steering handles.

As a result of the structure, the cabin no longer needs a central indent to accommodate the steering shaft of the cargo frame, and the space can instead be used for storing more items or as a foundation of ra seating area depending on the type of cabin attached.

Referring to FIG. 35, another view of the pulley assembly is shown disposed within the tubular cage structure of the front frame module.

As can be seen, the upper steering shaft 6.2 which is connected to the steering handles ends in the first central pulley 6.3c, the cable is wrapped around this first pulley, breaking the steering mechanism into two separate lines. These lines are threaded into the tubing of the U-structure through the noodle assemblies 6.3d, turned 90 degrees to the side by 6.3e, then then turned 90 degrees downwards by the smaller left and right pulleys 6.4.a.l and 6.4.l.r within the U-structure tubing.

A second pair of smaller left and right pulleys 3.4.l.r. and 3.4.i.l turn the cable 90 degrees to the horizontal plane, threading it deeper into the cage structure before wrapping it around a third pair of smaller pulleys 6.3.l.l. and 6.3.l.r which turn it 270 degrees, reversing the orientation so that it wraps around the second central pulley 6.3 in the same orientation as it does the top pulley, meaning that the pulley assembly does not reverse the direction of the steering handles.

As can be seen form the lower illustration, the second central pulley 6.3.m is connected to a second steering shaft 6.3.k which in turn is connected by a butterfly joint 6.5.b to the opposing suspension arms 6.5.a.l and 6.5.a.r.

Referring to FIG. 36, the entire pulley assembly and the U-structure and upper portion of the cage of the front frame through which the pulley assembly is threaded are both shown in an exploded components view. 6.3.m is the head tube cylinder for the lower central pulley and 6.2.a and 6.2.b are the head tube cylinder for the upper central pulley.

Referring to FIG. 37 and FIG. 38, various views are shown of the cargo bike suspension and telescopic tube mechanism disposed within the cage structure at various stages of extension. Specifically these images show how the various structures interlock as the rear module slides forward into and underneath the front module. Since the cage structure keeps the central area underneath the steering handles free to receive the centrally located seating assembly of the rear module. The sliding is facilitated seamlessly by the telescopic tube assembly 6.1 and as can be seen, the design and various improvements are highly synergistic and allow for perfect interlocking of the two modules.

Referring to FIG. 39, the rear frame module stride system is shown both open and closed, the configuration is similar in construction to that described for the first embodiment. As can be seen, the rider can still stand on the stride system when the bike is fully closed.

Referring to FIG. 40, additional close up views of the stride system are shown without the rider standing on it.

Referring to FIG. 41, the lock mechanism for the stride system in the improved embodiment is shown in more detail. As can be seen, it comprises the stride pedal 6.8.1, the foundation 6.8.2 connecting the pedal to the frame, an inner cylinder 6.8.3, a lock bar ring for keeping th pedal closed 6.8.4, a lock bar 6.8.5, a lock handle bar head with a silicone head to facilitate opening the pedals form closed position, an opening 6.8.7 to facilitate easy closing of the bar, pedal stride head bar lock ring 6.8.8, a stride pedal foundation with folded lock mode of the stride 6.8.2.b, and a lock bar in the lock ring in closed mode 6.8.6.

Referring to FIG. 42, the retractable suitcase rack 7.0.a is shown in more detail. As can be seen, the tray pops out of the cage structure of front module, having been concealed as part of the cover due to support element 7.0.b being aligned with the lower housing of the front module of the cargo bike. The vertical support element 7.0.b may also be telescopic and adjustable in height to ensure the luggage is well braced against the bike frame.

The pop-out functionality is enabled via a spring mechanism and pair of telescopic arms 7.0.c that are released from a locked position when the user presses the support element 7.0.c inwards.

The tray system has a main aluminum tube, which similarly to the dual head mechanism comprises an inner thin Nylon6 aluminum tube a plurality of openings along its length that interlock with a pin next to the spring mechanism 7.0.c, allowing the rack to extend outwards form the front of the bike to a desired length and support luggage of various sizes up to 42 cm in width.

Referring to FIG. 43, batteries for the cargo bike drive system are shown disposed within the front module frame cage structure. As mentioned above, it is often beneficial to house the batteries at the very front of the cage structure both for ease of access and to distribute the weight of the cargo bike properly.

In the present example, both left 6.3.b.l and right 6.3.b.r batteries are stored within the cage structure allowing for long distance electric motor travel. They can be accessed via the front cover doors 3.4.e as described above and can be either pulled out or charged in-situ. A retractable telescopic arm 3.4.e.1 allows the doors to remain supported when open

Referring to FIG. 44, a cargo cabin box is shown mounted on the front module of the improved embodiment of the cargo bike to illustrate the connection.

As can be seen, the children seated inside the cabin are positioned in a way that would not be possible with the previous embodiment, because the central portion of the upper cabin does not need to accommodate the steering shaft of the front frame.

The cargo bike is shown fully retracted/closed with the rear frame seat 5.1.c and its support tube 5.1.c.a occupying a space in the central lower portion of the cabin, which does still need to be indented, but to a much lower height allowing for specially designed cabins mounted on the be frame to maximize the amount of space and even use the lower indent as a base for an internal seating area.

By specially designed cabin it is meant that only the central lower portion is indented and also that the rear bottom corners of the cabin 8.0.e.r are extended downwards to rest atop the rear lower portion of the cage structure of the front module.

FIGS. 45 to 47 illustrate various possible configurations of specially adapted cargo cabins 8.0 for use with the improved embodiment of the bike frame.

FIG. 45 shows a rear view of the rear module entering the lower indent 8.0.b of the cabin when the cargo bike is in closed mode. As mentioned, it may be used as a support base for the seating structure 8.1.r and 8.1.l.

The example generic cabin body is shaped to facilitate easy to addition and removal of kids seats using side tracks for seat plates and back support plates.

Furthermore, the cabin can be provided with a telescopic roof structure, which may be mounted on foundation points 8.0.a.1, 8.0.a.2, 8.0.a.3, and 8.0.a.4.

Referring to FIG. 46, a cabin structure is shown which may both be used by families for transporting children as well as for deliveries.

The front portion may comprise a door 8.2 that may in some cases be made of a different material, the rear bottom corners 8.0.e.e.l and 8.0.e.r both extend downwards around the central indent 8.0.d, so that they rest on the rearward portions of the front module of the cargo bike cabin mount and provide additional support. The central indent 8.0.d is disposed within a slightly wider lower indent 8.0.d.1 and 8.0.d.2 that compensates for the shape of the cargo bike frame.

The interior of the cabin comprises a vertical seat plate track 8.0.c.v and horizontal seat plate track 8.0.c.h for receiving and supporting a seating attachment as described above.

Referring to the lower drawings, and as described above, the cabin may also comprise an adjustable roof structure attachment 8.3, which may be a simple frame or a larger fabric cover such as 8.3.a.

FIG. 47 shows such a roof structure being adjusted to various heights, form retracted 8.3.1 when no cover is needed although it can still act as a safety bar for keeping children from falling out, to partially extended 8.3.2 which is sufficiently high to provide roof cover for small children, to fully extended 8.3.3 that can effectively cover larger children.

The lower illustrations disclose the foundations for the roof structure that are built into the cabin frame and configured to receive the four corners in another telescopic tube arrangement 8.0.a.2 with a pin release mechanisms 8.0.b.2 and 8.0.b.4.

Close ups of the door mount 8.2.1 and lock 8.0.c, the sides of the cabin having a lower pocket lid/cover 8.0.e.l.1, and 8.0.c.v & 8.0.c.h horizontal and vertical seat plate tracks are also shown.

Referring to FIG. 48, to scale schematics of example applications enabled by the disclosed cargo bike and cabin are shown, including travelling families having children, two parents, and luggage and a smaller family of a single parent with children carrying luggage in scooter mode.

### APPLICATIONS

Some situations where the frame and cabin solutions of the present invention make door to door access more possible for cargo bike users are as follows:

A. Families with children’s small children’s up to 13 years old.

B. Delivery companies such as DHL, UPS, and local post office that need to deliver to the doorstep and food deliveries that need to keep the food warm/cold to the doorstep.

C. The tourism industry that can have the advantage to carry the kids from the airport and enter the metro/train as a stroller.

D. Professional and handy peoples that need to access small areas that requiring elevators for fixing in the apartment and get with their equipment to the fixing point.

E. Indoor transportation that can maneuver as a super small length trolley mode with the luggage in crowded areas. Now they can do it with an almost entirely closed mode of the frame and with the power of electricity only in a standing mode. (via the hand thrower that allows in EU and the word to move with 100% electric power from between 6 Kilometer per hour to 45 Kilometer per hour depending on the country regulations.

F. Advertising and sales point, in the street, supermarkets, and shopping malls. The bikes enable you to enter anywhere with a heavy load up to 180 kg. Therefore 1 person can maneuver singly and create the job alone without any further logistics.

G. Portable sales and branding booths that can service customers to their step door.

H. Health care, Norse, and doctor and visits. The frame can provide a space handicap chair base for transporting handicapped for easy outdoor trips for long-distance and with the integration of trains and metros without removing the person from his seat in any of the shifting. (so a nurse can control full logistics with this bikes).

### DEFINITIONS

The term “open mode” as used herein is synonymous with the term “cargo bike mode” as used herein and are intended to refer to the cargo bike of the present invention being in a fully extended position with the telescopic tubes at their maximum length whilst remaining attached to each other.

The term “partially closed mode” as used herein is synonymous with the term “scooter mode” as used herein and are intended to refer to the cargo bike of the present invention being in a partially extended position with the telescopic tubes between their maximum and minimum lengths, with the frame still allowing a rider to rest comfortably on the seat or stand on the stride pedals and propel the cargo bike forward using an electric drive or other motor.

The terms “closed mode” as used herein is synonymous with the term “stroller mode” as used herein and are intended to refer to the cargo bike of the present invention being in a fully compressed position with the telescopic tubes at their minimum length and some components of the first and second modules overlapping vertically but not interfering with each other.

### CONCLUSION

The disclosed embodiments are illustrative, not restrictive. While specific configurations of the cargo bike frame, cargo bike cabin, and cargo bike steering mechanism have been described in a specific manner referring to the illustrated embodiments, it is understood that the present invention can be applied to a wide variety of cargo bike solutions which fit within the scope and spirit of the claims. There are many alternative ways of implementing the invention.

1. A cargo bike frame, comprising:
a first module, the first module comprising a drive system and a first frame section comprising a dual head mechanism mounted to a central frame portion, the dual head mechanism having first and second openings forming a pair of first telescopic tube elements; and
a second module, the second module comprising a steering system, a suspension system, and a second frame section having a cargo cabin mount and two inner tubes forming a second pair of telescopic tube elements;
wherein the first pair of telescopic tube elements are configured to receive and thus detachably connect to the second pair of telescopic tube elements to form two telescopic tubes of adjustable length, thereby connecting the first module to the second module at an adjustable distance;
and wherein, when the cargo bike frame is in an upright standing position, the one or more telescopic tubes are in a substantially horizontal position at a height lower than the heights of the steering system and the suspension system.

2. A cargo bike frame according to claim 1, further comprising a length-locking means within the dual head whereby one or more of the telescopic tubes are configured with a plurality of lock points, enabling the distance between the first module and the second module to be set to a corresponding plurality of predetermined distances.

3. A cargo bike frame according to claim 2, wherein the length-locking mechanism comprises a plurality of pin holes in one or more of the second telescopic tube elements and a pin-lock mechanism configured to insert a pin in one of the plurality of pin holes.

4. A cargo bike frame according to claim 3, wherein a user may control the length-locking mechanism via actuation of a trigger located on the second module.

5. A cargo bike frame according to claim 4, wherein both of the telescopic tubes are incorporated into the length locking mechanism, and wherein the trigger operates a pair of cables connected to a pair of spring mechanisms within the dual head for operating the pin-locks.

6. A cargo bike frame according to claim 1, wherein the first pair of openings forming the first telescopic tube elements act as female telescopic tube elements and the second pair of telescopic tube elements act as male telescopic tube elements configured to slide through and parallel to the first telescopic tube elements.

7. A cargo bike frame according to claim 6, wherein the first pair of telescopic tube elements comprise an inner coating configured to reduce friction with respect to the second telescopic tube elements.

8. A cargo bike frame according to claim 7, wherein the inner coating is formed of Nylon6 or polypropylene.

9. A cargo bike frame according to claim 1, wherein the second module is configured to receive and support a cargo cabin which is up to 800 mm in length.

10. A cargo bike frame according to claim 1, wherein the variable distance between the first and second modules afforded by the telescopic tube configuration allows for the assembled cargo bike to reduce its length by up to 44% from a first full length open position to a second minimum length closed position.

11. A cargo bike frame according to claim 1, wherein the drive system comprises a crankset.

12. A cargo bike frame according to claim 1, wherein the drive system comprises and electric motor.

13. A cargo bike frame according to claim 11, wherein the electric motor is a rear wheel hub mounted motor.

14. A cargo bike frame according to claim 11, wherein the electric motor is a mid-drive system.

15. A cargo bike frame according to claim 11, wherein the first module further comprises a rear wheel hub fitted either side with a stride pedal configured to allow a rider to stand on in an ergonomically comfortable position.

16. A cargo bike frame according to claim 14, wherein the frame is configured such that the stride pedals do not vertically overlap with any other components of the rear module of the cargo bike frame regardless of the position of the first module relative to the second module and the positions of the telescopic tubes.

17. A cargo bike frame according to claim 14, wherein the stride pedals are configured to be rotatable by 90 degrees with respect to rear wheel hub.

18. A cargo bike frame according to claim 16, wherein the stride pedals further include a mechanism for locking them into place against the cargo bike frame when not in use.

19. A cargo bike frame according to claim 1, wherein the second module forms a reinforced cage structure to support the cargo cabin mount.

20. A cargo bike frame according to claim 19, wherein the reinforced cage structure comprises an upper layer configured to receive a cargo cabin and support the base of an adapted steering system, and a lower layer shaped to encompass the suspension and telescopic tube mechanism, the upper layer and lower layer being vertically connected by one or more reinforced bridges.

21. A cargo bike frame according to claim 20, wherein the steering system is adapted to keep a central space beneath the steering handles free for the seat of the first module to slide into, and is further adapted to keep a space in front of the steering handles free to maximize space for the cargo cabin.

22. A cargo bike frame according to claim 21, wherein the steering system comprises a shortened central steering shaft disposed rearwards of the cabin mount and ending in a first central pulley having a steering cable disposed thereon which connects via a left pulley assembly and a right pulley assembly to a second central pulley disposed within the reinforced cage structure and which confers turning motion applied to the steering handles to a second shaft connected to the frame suspension.

23. A cargo bike frame according to claim 1, wherein the second module comprises a retractable tray mechanism for supporting one or more luggage items on a front of the cargo bike in addition to the cabin.

24. A cargo bike frame according to claim 23, wherein the retractable tray mechanism is spring operated such that the tray slides out automatically when pressed inwards.

25. A cargo bike frame according to claim 1, wherein the first module comprises a retractable handle disposed rearwards of the seat for a passenger to grip.

26. A cargo bike frame section, comprising:
a cargo cabin support frame,
one or more front wheel axel fittings;
a steering system comprising a rotatable vertical steering beam configured to change the angle of the one or more front wheel axel fittings upon rotation about its vertical axis, and a rotatable handlebar configured to cause the steering beam to rotate about its vertical axis;
wherein the axis of rotation of the handlebar is offset a distance of at least 10 cm rearwards from the axis of rotation of the steering beam.

27. A cargo cabin box for a cargo bike, the cargo cabin box having an indent located at the centre of its rear wall configured to receive a seat of a rear module of the cargo bike.

28. A cargo cabin box for a cargo bike according to claim 27, the indent of the cargo cabin box forming a base for an internal seating arrangement of the cargo cabin box.

29. A cargo cabin box for a cargo bike according to claim 27, the cargo cabin box having an adjustable height retractable roof frame.
